(19) United States
(12) Patent Application Publication
(10) Pub. No.: US 2016/0371392 A1
(43) Pub. Date: Dec. 22, 2016

(54) SELECTIVELY INDEXING DATA ENTRIES WITHIN A SEMI-STRUCTURED DATABASE

(71) Applicant: QUALCOMM Incorporated, San Diego, CA (US)

(72) Inventors: Craig Matthew BROWN, New South Wales (AU); Xavier Claude FRANC, Sarthe (FR); Michael William PADDON, Tokyo (JP); Matthew Christian DUGGAN, Tokyo (JP); Kento TARUI, Tokyo (JP)

(21) Appl. No.: 14/864,577

(22) Filed: Sep. 24, 2015

Related U.S. Application Data
(60) Provisional application No. 62/180,968, filed on Jun. 17, 2015.

(51) Int. Cl. G06F 17/30

(52) U.S. Cl. CPC G06F 17/30911

(57) ABSTRACT

In an embodiment, a server indexes, in a label-path indexed database, a first data entry at a first target node with a given node identifier in accordance with a label-path indexing protocol. After determining that a number of paths from the root node to non-root nodes that share the given node identifier exceeds a threshold, the server indexes a second data entry at a second target node with the given node identifier in a flat-indexed database in accordance with a flat indexing protocol. In an alternative embodiment, the server indexes the first data entry redundantly in both the label-path indexed database and the flat-indexed database while the path number does not exceed the threshold. When the path number exceeds the threshold, the second data entry is indexed in the flat-indexed database only.

### CROSS-REFERENCE TO RELATED APPLICATION

The present application for patent claims the benefit of U.S. Provisional Application No. 62/180,968, entitled “SELECTIVELY INDEXING DATA ENTRIES WITHIN A SEMI-STRUCTURED DATABASE”, filed Jun. 17, 2015, assigned to the assignee hereof, and expressly incorporated herein by reference in its entirety.

### BACKGROUND

1. Field

This disclosure relates to selectively indexing data entries within a semi-structured database.

2. Description of the Related Art

Databases can store and index data in accordance with a structured data format (e.g., Relational Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with Name, Industry and Headquarters values, a new Bibliography data object may be required to be added with Author, Title, Journal and Date values, and so on). By contrast, in unstructured databases, new data objects can be added verbatim, so similar data objects can be added via different formats which may cause difficulties in establishing semantic relationships between the similar data objects.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a plurality of nodes arranged in a tree hierarchy. The document structure includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

### SUMMARY

An example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method includes obtaining a first data entry to be indexed at a first target node with a given node identifier within a given document among the set of documents, and indexing, in a label-path indexed database, the first data entry in accordance with a label-path indexing protocol that records both a path between the root node and the first target node and the given node identifier for the first target node. The example method further includes determining that a number of paths from the root node to non-root nodes that share the given node identifier exceeds a threshold, obtaining, after the determining, a second data entry to be indexed at a second target node with the given node identifier within the given document and indexing, in a flat-indexed database in response to the determining, the second data entry in accordance with a flat indexing protocol that records the given node identifier for the second target node without recording the path between the root node and the second target node.

Another example relates to a method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example method may include obtaining a first data entry to be indexed at a first target node with a given node identifier within a given document among the set of documents, indexing, in a label-path indexed database, the first data entry in accordance with a label-path indexing protocol that records both a path between the root node and the first target node and the given node identifier for the first target node, and redundantly indexing, in a flat-indexed database, the first data entry in accordance with a flat indexing protocol that records the given node identifier for the first target node without recording the path between the root node and the first target node. The example method may further include determining that a number of paths from the root node to non-root nodes that share the given node identifier exceeds a threshold, obtaining, after the determining, a second data entry to be indexed at a second target node with the given node identifier within the given document and indexing, only in the flat-indexed database in response to the determining, the second data entry in accordance with the flat indexing protocol.

Another example relates to a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example server may include logic configured to obtain a first data entry to be indexed at a first target node with a given node identifier within a given document among the set of documents, logic configured to index, in a label-path indexed database, the first data entry in accordance with a label-path indexing protocol that records both a path between the root node and the first target node and the given node identifier for the first target node, logic configured to determine that a number of paths from the root node to non-root nodes that share the given node identifier exceeds a threshold, logic configured to obtain, after the determination, a second data entry to be indexed at a second target node with the given node identifier within the given document and logic configured to index, in a flat-indexed database in response to the determination, the second data entry in accordance with a flat indexing protocol that records the given node identifier for the second target node without recording the path between the root node and the second target node.

Another example relates to a server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries. The example server includes logic configured to obtain a first data entry to be indexed at a first target node with a given node identifier within a given document among the set of documents, logic configured to index, in a label-path indexed database, the first data entry in accordance with a label-path indexing protocol that records both a path between the root node and the first target node and the given node identifier for the first target node, logic configured to redundantly index, in a flat-indexed database, the first data entry in accordance with a flat indexing protocol that records the given node identifier for the first target node without recording the path between the root node and the first target node, logic configured to determine that a number of paths from the root node to non-root nodes that share the given node identifier exceeds a threshold, logic configured to obtain, after the determining, a second data entry to be indexed at a second target node with the given node identifier within the given document and logic configured to index, only in the flat-indexed database in response to the determining, the second data entry in accordance with the flat indexing protocol.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipments (UEs) in accordance with embodiments of the disclosure.

FIG. 3 illustrates a communication device that includes logic configured to perform functionality in accordance with an embodiment of the disclosure.

FIG. 4 illustrates a server in accordance with an embodiment of the disclosure.

FIG. 5A illustrates an example of nodes in a tree hierarchy for a given document in accordance with an embodiment of the disclosure.

FIG. 5B illustrates an example of a context tree for the document depicted in FIG. 5A in accordance with an embodiment of the disclosure.

FIG. 5C illustrates another example of a context tree in accordance with another embodiment of the disclosure.

FIG. 6A illustrates a more detailed example of the tree hierarchy depicted in FIG. 5A in accordance with another embodiment of the disclosure.

FIG. 6B illustrates a flat element index for an XML database in accordance with an embodiment of the disclosure.

FIG. 6C illustrates a context tree for an XML database in accordance with an embodiment of the disclosure.

FIG. 7A illustrates an example procedure of adding (or indexing) new data entries into a flat-indexed, semi-structured database that is maintained at a semi-structured database server in accordance with a flat-indexing protocol.

FIG. 7B illustrates an example procedure of adding (or indexing) new data entries into a label-path indexed, semi-structured database that is maintained at the semi-structured database server in accordance with a label-path indexing protocol.

FIG. 8 illustrates a graph comparing the label-path indexing to the flat-indexing protocol.

FIG. 9A is directed to a process of indexing data entries in a semi-structured database that is maintained at the semi-structured database server in accordance with an embodiment of the disclosure.

FIG. 9B illustrates an example implementation of the process of FIG. 9A in accordance with an embodiment of the disclosure.

FIG. 10A illustrates a continuation of the process of FIG. 9B in accordance with an embodiment of the disclosure.

FIG. 10B illustrates a continuation of the process of FIG. 9B in accordance with another embodiment of the disclosure.

FIG. 11 illustrates a process of executing a series of search queries during the process of FIG. 9B in accordance with an embodiment of the disclosure.

FIG. 12 illustrates another process of executing a series of search queries during the process of FIG. 9B in accordance with an alternative embodiment of the disclosure.

FIG. 13 is directed to a process of indexing data entries in a semi-structured database that is maintained at the semi-structured database server in accordance with another embodiment of the disclosure.

FIG. 14 illustrates a process of executing a series of search queries during the process of FIG. 13 in accordance with an embodiment of the disclosure.

### DETAILED DESCRIPTION

Aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a wired access network and/or a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. In an embodiment, UEs can communicate with a core network via a RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to cellular telephones, personal digital assistants (PDAs), pagers, laptop computers, desktop computers, PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

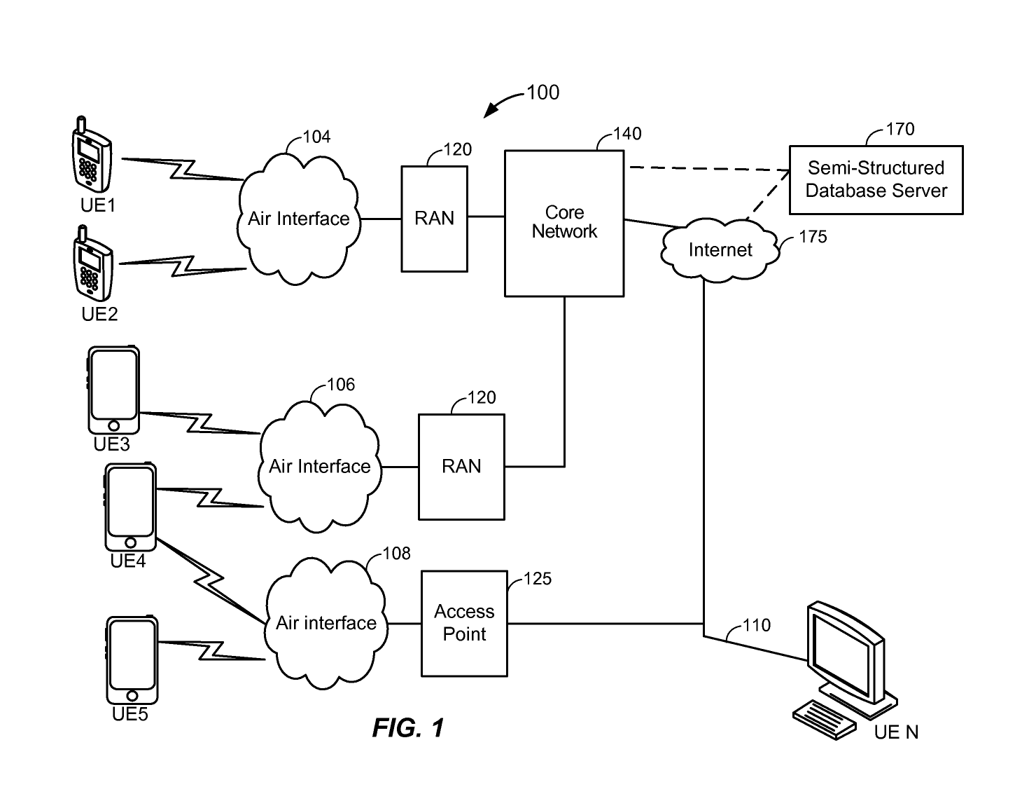

FIG. 1 illustrates a high-level system architecture of a wireless communications system 100 in accordance with an embodiment of the disclosure. The wireless communications system 100 contains UEs 1 . . . N. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., a RAN 120, an access point 125, etc.) over a physical communications interface or layer, shown in FIG. 1 as air interfaces 104, 106, 108 and/or a direct wired connection 110. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 may include a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 may be configured to connect to a core network 140 that can perform a variety of functions, including bridging circuit-switched (CS) calls between UEs served by the RAN 120 and other UEs served by the RAN 120 or a different RAN altogether, and may also mediate an exchange of packet-switched (PS) data with external networks such as Internet 175.

The Internet 175, in some examples, includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UEs 1 . . . N via the core network 140. Also shown in FIG. 1 is the access point 125 that is separate from the RAN 120. The access point 125 may be connected to the Internet 175 independent of the core network 140 (e.g., via an optical communications system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, a semi-structured database server 170 is shown as connected to the Internet 175, the core network 140, or both. The semi-structured database server 170 can be implemented as a plurality of structurally separate servers (i.e., a distributed server arrangement), or alternately may correspond to a single server. The semi-structured database server 170 is responsible for maintaining a semi-structured database (e.g., an XML database, a JavaScript Object Notation (JSON) database, etc.) and executing search queries within the semi-structured database on behalf of one or more client devices, such as UEs 1 . . . N as depicted in FIG. 1. In some implementations, the semi-structured database server 170 can execute on one or more of the client devices as opposed to a network server, in which case the various client devices can interface with the semi-structured database server 170 via network connections as depicted in FIG. 1, or alternatively via local or peer-to-peer interfaces. In another example, the semi-structured database server 170 can run as an embedded part of an application on a device (e.g., a network server, a client device or UE, etc.). In this case, where the semi-structured database server 170 is implemented as an application that manages the semi-structured database, the application can operate without the need for inter-process communication between other applications on the device.

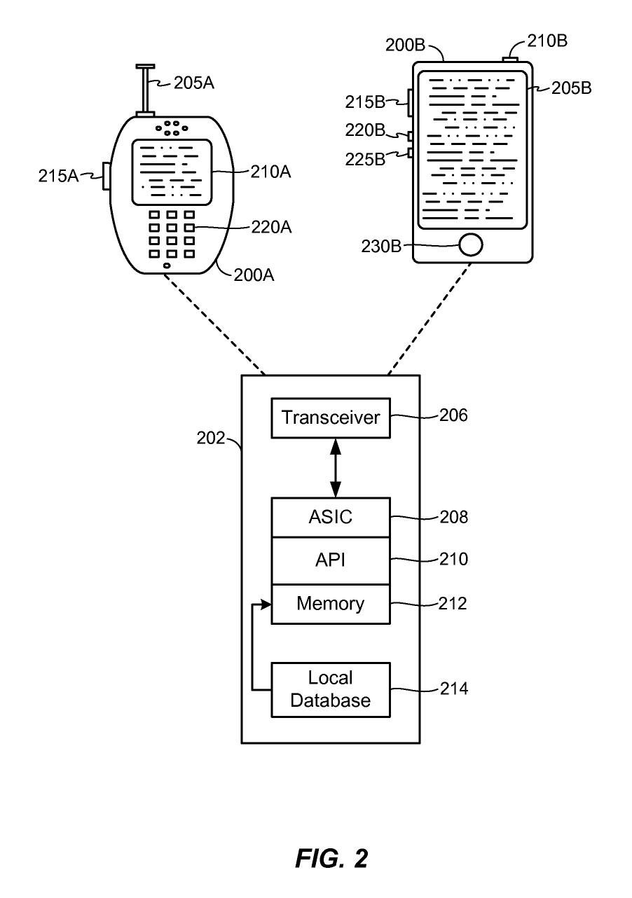

FIG. 2 illustrates examples of UEs (i.e., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of UE 200B, UE 200B can include one or more external antennas and/or one or more integrated antennas that are built into the external casing of UE 200B, including but not limited to WiFi antennas, cellular antennas, satellite position system (SPS) antennas (e.g., global positioning system (GPS) antennas), and so on.

While internal components of UEs such as UEs 200A and 200B can be embodied with different hardware configurations, a basic high-level UE configuration for internal hardware components is shown as platform 202 in FIG. 2. The platform 202 can receive and execute software applications, data and/or commands transmitted from the RAN 120 that may ultimately come from the core network 140, the Internet 175 and/or other remote servers and networks (e.g., the semi-structured database server 170, web URLs, etc.). The platform 202 can also independently execute locally stored applications without RAN interaction. The platform 202 can include a transceiver 206 operably coupled to an application specific integrated circuit (ASIC) 208, or other processor, microprocessor, logic circuit, or other data processing device. The ASIC 208 or other processor executes the application programming interface (API) 210 layer that interfaces with any resident programs in a memory 212 of the wireless device. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like.

Accordingly, an embodiment of the disclosure can include a UE (e.g., UE 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the ASIC 208, the memory 212, the API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of UEs 200A and 200B in FIG. 2 are to be considered merely illustrative and the disclosure is not limited to the illustrated features or arrangement.

The wireless communications between UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the disclosure and are merely to aid in the description of aspects of embodiments of the disclosure.

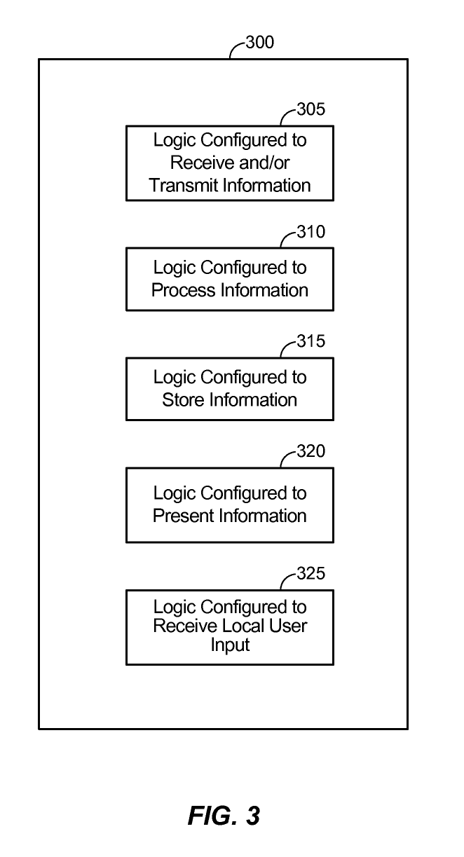

FIG. 3 illustrates a communications device 300 that includes logic configured to perform functionality in accordance with an embodiment of the disclosure. The communications device 300 can correspond to any of the above-noted communications devices, including but not limited to UEs 200A or 200B, any component of the RAN 120, any component of the core network 140, any components coupled with the core network 140 and/or the Internet 175 (e.g., the semi-structured database server 170), and so on. Thus, the communications device 300 can correspond to any electronic device that is configured to communicate with (or facilitate communication with) one or more other entities over the wireless communications system 100 of FIG. 1.

Referring to FIG. 3, the communications device 300 includes logic configured to receive and/or transmit information 305. In some embodiments such as when the communications device 300 corresponds to a wireless communications device (e.g., UE 200A or 200B, the access point 125, a BS, Node B or eNodeB in the RAN 120, etc.), the logic configured to receive and/or transmit information 305 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). For example, the communications device 300 may correspond to some type of network-based server (e.g., the semi-structured database server 170, etc.), and the logic configured to receive and/or transmit information 305 can correspond to an Ethernet card that connects the network-based server to other communication entities via an Ethernet protocol.

In a further example, the logic configured to receive and/or transmit information 305 can include sensory or measurement hardware by which the communications device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, in various implementations, the logic configured to receive and/or transmit information 305 does not correspond to software alone, and the logic configured to receive and/or transmit information 305 relies at least in part upon hardware to achieve its functionality.

The communications device 300 of FIG. 3 may further include logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communications device 300 to perform measurement operations, converting information from one format to another (e.g., between different protocols such as .wmv to .avi, etc.), and so on. For example, the processor included in the logic configured to process information 310 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 310 can also include software that, when executed, permits the associated hardware of the logic configured to process information 310 to perform its processing function(s). However, in various implementations, the logic configured to process information 310 does not correspond to software alone, and the logic configured to process information 310 relies at least in part upon hardware to achieve its functionality.

The communications device 300 of FIG. 3 may further include logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM memory, flash memory, ROM memory, EPROM memory, EEPROM memory, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, in various implementations, the logic configured to store information 315 does not correspond to software alone, and the logic configured to store information 315 relies at least in part upon hardware to achieve its functionality.

The communications device 300 of FIG. 3 may further include logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communications device 300. For example, if the communications device 300 corresponds to UE 200A or UE 200B as shown in FIG. 2, the logic configured to present information 320 can include the display 210A of UE 200A or the touchscreen display 205B of UE 200B. In a further example, the logic configured to present information 320 can be omitted for certain communications devices, such as network communications devices that do not have a local user (e.g., network switches or routers, remote servers such as the semi-structured database server 170, etc.). The logic configured to present information 320 can also include software that, when executed, permits the associated hardware of the logic configured to present information 320 to perform its presentation function(s). However, in various implementations, the logic configured to present information 320 does not correspond to software alone, and the logic configured to present information 320 relies at least in part upon hardware to achieve its functionality.

The communications device 300 of FIG. 3 may further include logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communications device 300. For example, if the communications device 300 corresponds to UE 200A or UE 200B as shown in FIG. 2, the logic configured to receive local user input 325 can include the keypad 220A, any of the buttons 215A or 210B through 225B, the touchscreen display 205B, etc. In a further example, the logic configured to receive local user input 325 can be omitted for certain communications devices, such as network communications devices that do not have a local user (e.g., network switches or routers, remote servers such as the semi-structured database server 170, etc.). The logic configured to receive local user input 325 can also include software that, when executed, permits the associated hardware of the logic configured to receive local user input 325 to perform its input reception function(s). However, in various implementations, the logic configured to receive local user input 325 does not correspond to software alone, and the logic configured to receive local user input 325 relies at least in part upon hardware to achieve its functionality.

Referring to FIG. 3, while the configured logics 305 through 325 are shown as separate or distinct blocks in FIG. 3, it will be appreciated that the hardware and/or software by which the respective configured logics 305 through 325 performs its functionality can overlap in part or as a whole. For example, any software used to facilitate the functionality of the configured logics 305 through 325 can be stored in the non-transitory memory associated with the logic configured to store information 315, such that the configured logics 305 through 325 each performs their functionality (i.e., in this case, software execution) based in part upon the operation of software stored by the logic configured to store information 315. Likewise, hardware that is directly associated with one of the configured logics 305 through 325 can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

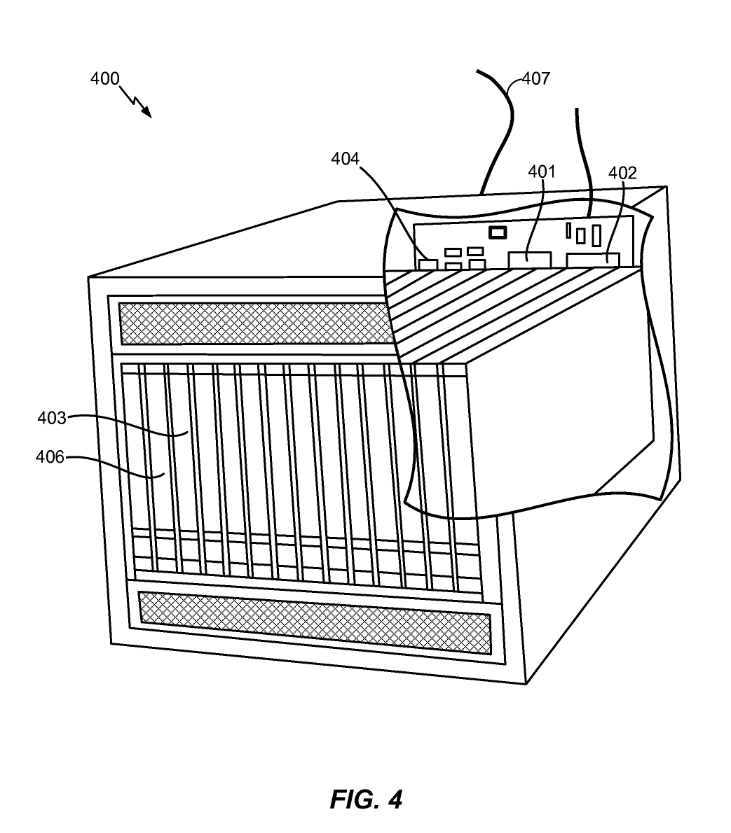

The various embodiments may be implemented on any of a variety of commercially available server devices, such as server 400 illustrated in FIG. 4. In an example, the server 400 may correspond to one example configuration of the semi-structured database server 170 described above. The server 400 may include a processor 401 coupled to a volatile memory 402 and a large capacity nonvolatile memory, such as a disk drive 403. The server 400 may also include a memory 406 (e.g., a floppy disc drive, compact disc (CD), a DVD disc drive, etc.) coupled to the processor 401. The server 400 may also include network access ports 404 coupled to the processor 401 for establishing data connections with a network via network connector 407, such as a local area network coupled to other broadcast system computers and servers or to the Internet. In context with FIG. 3, it will be appreciated that the server 400 of FIG. 4 illustrates one example implementation of the communications device 300, whereby the logic configured to transmit and/or receive information 305 corresponds to the network access ports 404 used by the server 400 to communicate via network connector 407, the logic configured to process information 310 corresponds to the processor 401, and the logic configured to store information 315 corresponds to any combination of the memory 406. The logic configured to present information 320 and the logic configured to receive local user input 325 are not shown explicitly in FIG. 4 and may or may not be included therein. Thus, FIG. 4 helps to demonstrate that the communications device 300 may be implemented as a server, in addition to a UE implementation as in FIG. 2.

Databases can store and index data in accordance with a structured data format (e.g., Relation Databases for normalized data queried by Structured Query Language (SQL), etc.), a semi-structured data format (e.g., XMLDBs for Extensible Markup Language (XML) data, RethinkDB for JavaScript Object Notation (JSON) data, etc.) or an unstructured data format (e.g., Key Value Stores for key-value data, ObjectDBs for object data, Solr for free text indexing, etc.). In structured databases, any new data objects to be added are expected to conform to a fixed or predetermined schema (e.g., a new Company data object may be required to be added with “Name”, “Industry” and “Headquarters” values, a new Bibliography data object may be required to be added with “Author”, “Title”, “Journal” and “Date” values, and so on). By contrast, in unstructured databases, new data objects are added verbatim, which permits similar data objects to be added via different formats which causes difficulties in establishing semantic relationships between the similar data objects.

Examples of structured database entries for a set of data objects may be configured as follows:

TABLE 1
Example of Structured Database Entry for a Company Data Object

| Name | Industry | Headquarters |
|---|---|---|
| Company X | Semiconductor; | San Diego, California, USA |
| | Wireless Telecommunications | |

whereby “Name”, “Industry” and “Headquarters” are predetermined values that are associated with each “Company”-type data object stored in the structured database, or

TABLE 2
Example of Structured Database Entry
for Bibliography Data Objects

| Author | Title | Journal | Date |
|---|---|---|---|
| Cox, J. | Company X races to retool | Network World | 2007 |
| | the mobile phone | | |
| Arensman, | Meet the New Company X | Electronic Business | 2000 |
| Russ | | | |

whereby “Author”, “Title”, “Journal” and “Date” are predetermined values that are associated with each “Bibliography”-type data object stored in the structured database.

Examples of unstructured database entries for the set of data objects may be configured as follows:

TABLE 3
Example of Unstructured Database
Entry for a Company Data Object

Company X is an American global semiconductor company that designs
and markets wireless telecommunications products and services. The
company headquarters are located in San Diego, California, USA.

TABLE 4
Example of Unstructured Database Entry
for Bibliography Data Objects

Cox, J. (2007). ‘Company X races to retool the mobile phone’. Network
World, 24/8: 26.
Arensman, Russ. “Meet the New Company X.” Electronic Business,
Mar. 1, 2000.

As will be appreciated, the structured and unstructured databases in Tables 1 and 3 and in Tables 2 and 4 store substantially the same information, with the structured database having a rigidly defined value format for the respective class of data object while the unstructured database does not have defined values associated for data object classes.

Semi-structured databases share some properties with both structured and unstructured databases (e.g., similar data objects can be grouped together as in structured databases, while the various values of the grouped data objects are allowed to differ which is more similar to unstructured databases). Semi-structured database formats use a document structure that includes a set of one or more documents that each have a plurality of nodes arranged in a tree hierarchy. The plurality of nodes are generally implemented as logical nodes (e.g., the plurality of nodes can reside in a single memory and/or physical device), although it is possible that some of the nodes are deployed on different physical devices (e.g., in a distributed server environment) so as to qualify as both distinct logical and physical nodes. Each document includes any number of data objects that are each mapped to a particular node in the tree hierarchy, whereby the data objects are indexed either by the name of their associated node (i.e., flat-indexing) or by their unique path from a root node of the tree hierarchy to their associated node (i.e., label-path indexing). The manner in which the data objects of the document structure are indexed affects how searches (or queries) are conducted.

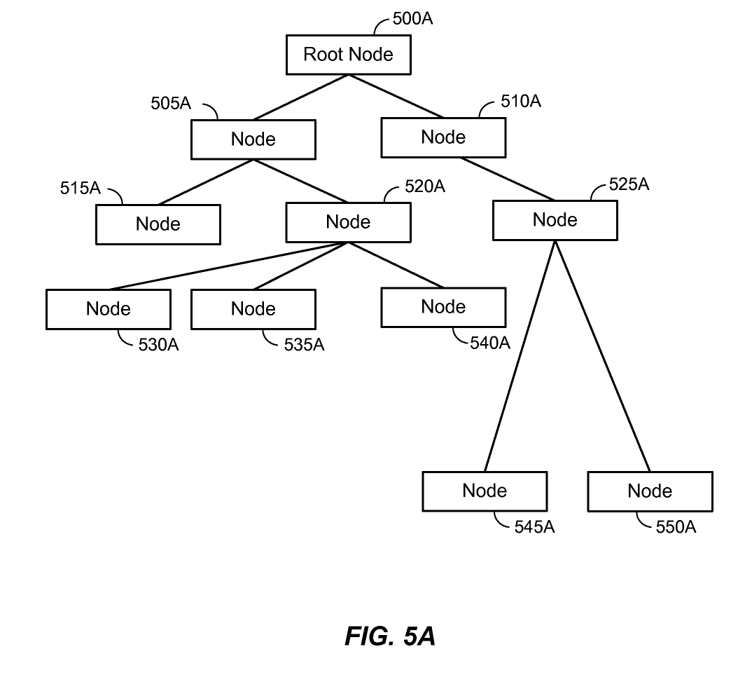

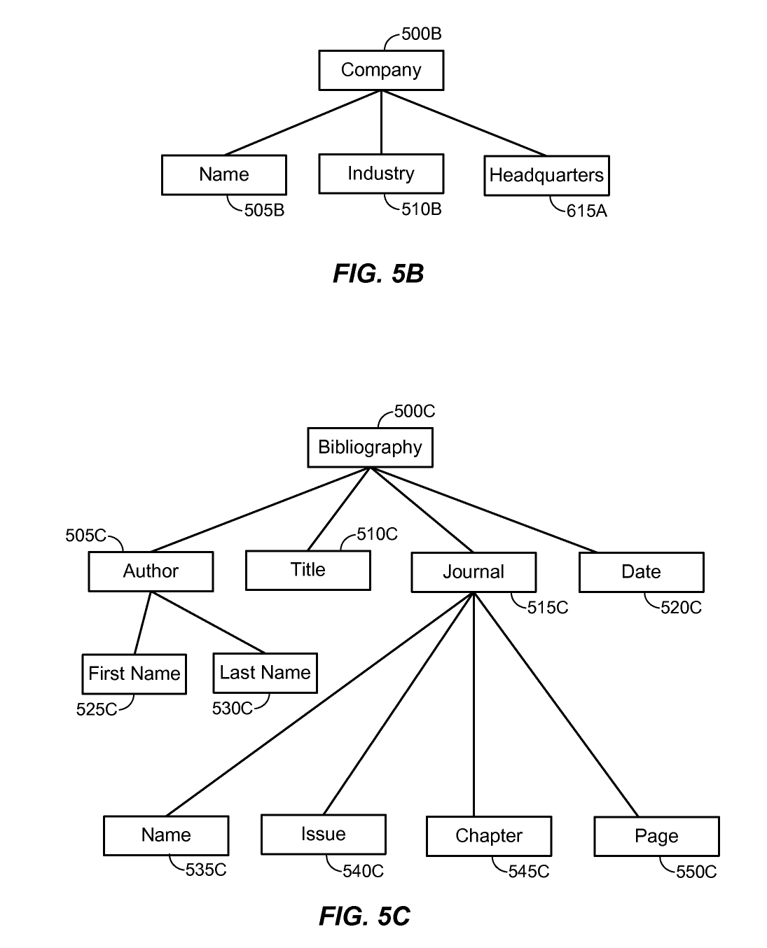

FIG. 5A illustrates a set of nodes in a tree hierarchy for a given document in accordance with an embodiment of the disclosure. As illustrated, a root node 500A contains descendant nodes 505A and 510A, which in turn contain descendant nodes 515A, 520A and 525A, respectively, which in turn contain descendant nodes 530A, 535A, 540A, 545A and 550A, respectively.

FIGS. 5B-5C illustrate examples of context trees for example documents in accordance with various embodiments of the disclosure. With respect to at least FIGS. 5B-5C, references to context paths and context trees are made below, with these terms being defined as follows:
Context Path: One node in a context tree.
Context Tree: The complete set of all paths in a set of documents.

FIG. 5B illustrates an example of the context tree for a “Company” document based on the data from Tables 1 and 3 (above). Referring to FIG. 5B, there is a root context path “Company” 500B, and three descendant context paths 505B, 510B, 515B for “Name”, “Industry” and “Headquarters” values, respectively. For a JSON-based semi-structured database, the data object depicted above in Tables 1 and 3 may be recorded as follows:

TABLE 5
Example of JSON-based Semi-Structured Database
Entry for a Company Data Object

```
{
  “Company”: “Company X”,
  “Industry”: [
```

“Semiconductor”,
“Wireless telecommunications” ],

“Headquarters” :

“San Diego, California, USA”

}

FIG. 5C illustrates an example of the context tree for a “Bibliography” document based on the data from Tables 2 and 4 (above). Referring to FIG. 5C, there is a root context path “Bibliography” 500C, which has four descendant context paths 505C, 510C, 515C and 520C for “Author”, “Title”, “Journal” and “Date”, respectively. The Author context path 505C further has two additional descendant context paths 525C and 530C for “First Name” and “Last Name”, respectively. Further, the context path “Journal” 515C has four descendant context paths 535C, 540C, 545C and 550C for “Name”, “Issue”, “Chapter” and “Page”, respectively. For an XML-based semi-structured database, the data object depicted above in Tables 2 and 4 that is authored by J. Cox may be recorded as follows:

TABLE 6
Example of XML-based Semi-Structured Database
Entry for a Bibliography Data Object

<Bibliography>

<Author>

<LastName>Cox</LastName>
<FirstName>J.</FirstName>

</Author>
<Title>Company X races ...</Title>
<Journal>

<Name>Network World</Name>
<Issue>24</Issue>
<Chapter>8</Chapter>
<Page>26</Page>

</Journal>
<Date>2007</Date>

</Bibliography>

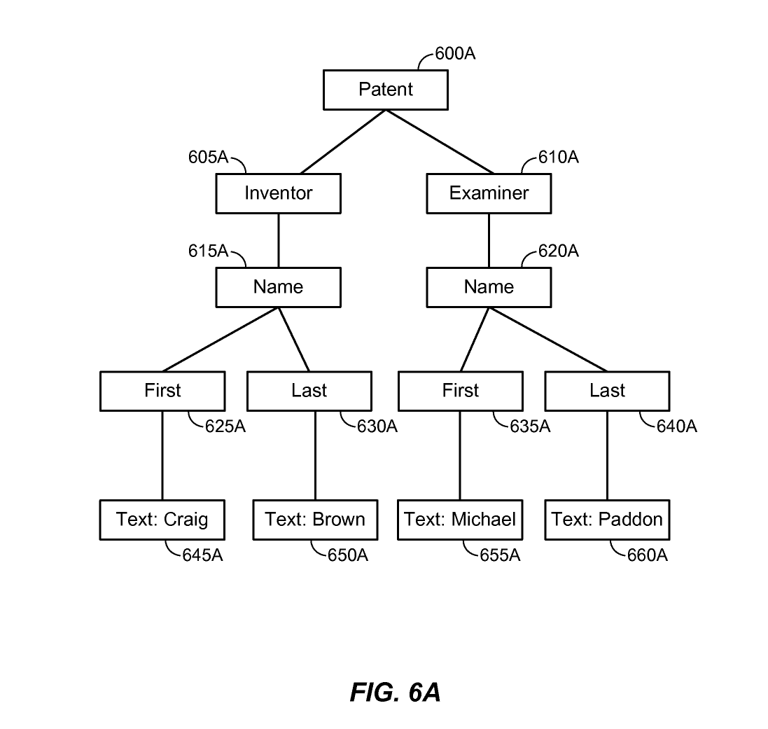

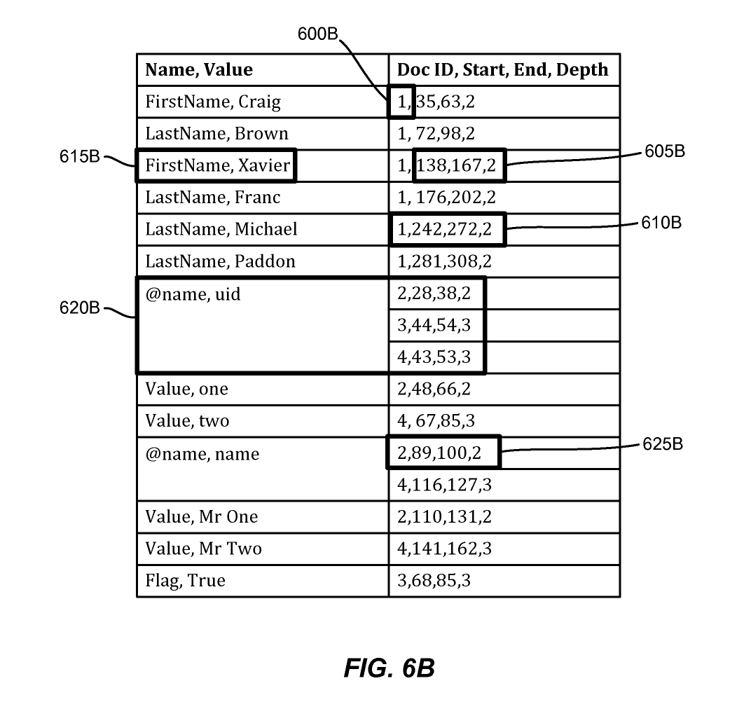

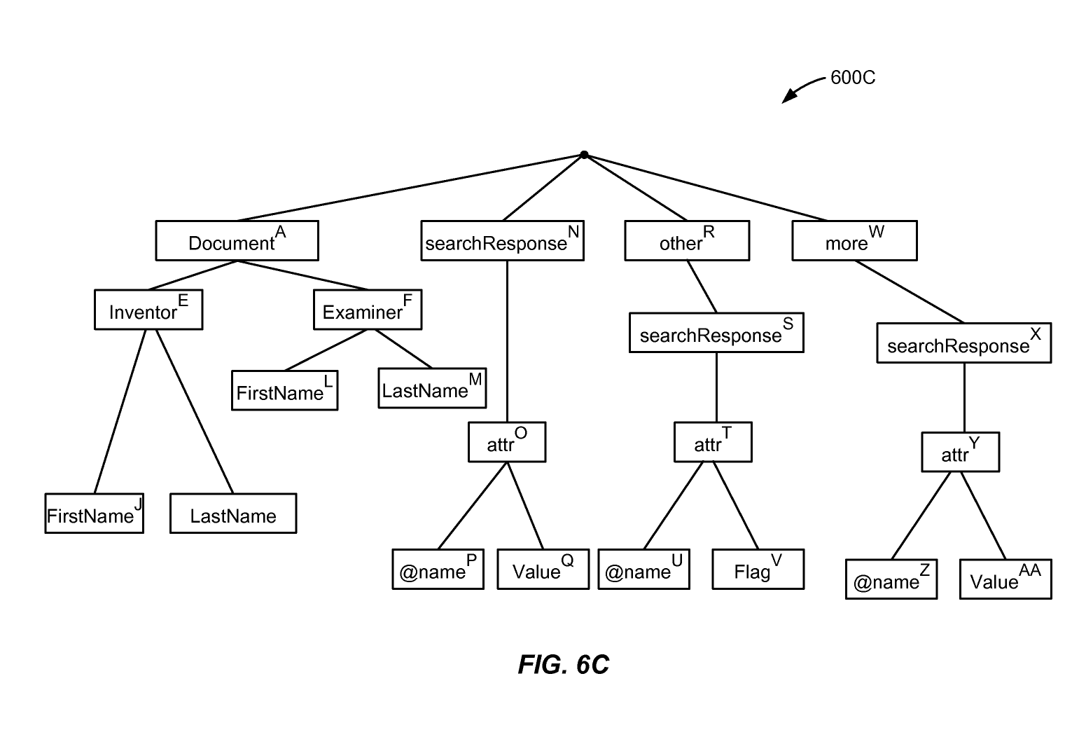

FIG. 6A illustrates an example context tree for a “Patent” document in accordance with an embodiment of the disclosure. In FIG. 6A, the document is a patent information database with a root node “Patent” 600A, which has two descendant nodes 605A and 610A for “Inventor” and “Examiner”, respectively. Each has a descendant node entitled “Name”, 615A and 620A, which in turn each have descendant nodes entitled “First” and “Last”, 625A, 630A, 635A and 640A. Further depicted in FIG. 6A are textual data objects that are stored in the respective nodes 625A-640A. In particular, for an Examiner named “Michael Paddon” and an inventor named “Craig Brown” for a particular patent document, the text “Craig” 645A is stored in a node represented by the context path /Patent/Inventor/Name/First, the text “Brown” 650A is stored in a node represented by the context path /Patent/Inventor/Name/Last, the text “Michael” 655A is stored in a node represented by the context path /Patent/Examiner/Name/First and the text “Paddon” 660A is stored in a node represented by the context path /Patent/Examiner/Name/Last. As will be discussed below in more detail, each context path can be associated with its own index entry in a Context Path Element Index, and each unique value at a particular context path can also have its own index entry in a Context Path Simple Content Index.

To put the document depicted in FIG. 6A into context with respect to XPath queries in an example where the semi-structured database corresponds to an XML database, an XPath query directed to /Patent/Inventor/Name/Last will return each data object at this context path within the tree hierarchy, in this case, “Brown”. In another scenario, the XPath query can implicate multiple nodes. For example, an XPath query directed to //Name/Last maps to both the context path /Patent/Inventor/Name/Last and the context path /Patent/Examiner/Name/Last, so this query would return each data object at any qualifying location of the tree hierarchy, in this case, both “Brown” and “Paddon”.

The document structure of a particular document in a semi-structured database can be indexed in accordance with a flat-indexing protocol or a label-path protocol. For example, in the flat-indexing protocol (sometimes referred to as a “node indexing” protocol) for an XML database, each node is indexed with a document identifier at which the node is located, a start-point and an end-point that identifies the range of the node, and a depth that indicates the node's depth in the tree hierarchy of the document (e.g., in FIG. 6A, the root node “Patent” 600A (or root context path) has depth=0, the “Inventor” and “Examiner” context paths 605A and 610A have depth=1, and so on). The range of any parent node envelops or overlaps with the range(s) of each of the parent node's respective descendant nodes. Accordingly, assuming that the document identifier is 40, the root node “Patent” 600A document depicted in FIG. 6A can be indexed as follows:

TABLE 7
Example of XML-based Tree Hierarchy Shown in FIG. 6A

<Patent>¹

<Inventor>²

<Name>³

<First>⁴Craig</First>⁵
<Last>⁶Brown</Last>⁷

</Name>⁸

</Inventor>⁹
<Examiner>¹⁰

<Name>¹¹

<First>¹²Michael</First>¹³
<Last>¹⁴Paddon</Last>¹⁵

</Name>¹⁶

</Examiner>¹⁷

</Patent>¹⁸

whereby each number represents a location of the document structure that can be used to define the respective node range, as shown in Table 8 as follows:

TABLE 8
Example of Flat-Indexing of Nodes of FIG. 6A Based on Table 7

| Name, Value | Docid, Start, End, Depth |
|---|---|
| Inventor | (40, 2, 9, 1) |
| Name | (40, 3, 8, 2), |
| | (40, 11, 16, 2) |
| Last, Brown | (40, 6, 7, 3) |
| Last, Paddon | (40, 14, 15, 3) |

Accordingly, the “Inventor” context path 605A of FIG. 6A is part of document 40, starts at location 2 and ends at location 9 as shown in Table 7, and has a depth of 1 in the tree hierarchy depicted in FIG. 6A, such that the “Inventor” context path 605A is indexed as (40,2,9,1) in Table 8. The “Name” context paths 615A and 620A of FIG. 6A are part of document 40, start at locations 3 and 11, respectively, and end at locations 8 and 16, respectively, as shown in Table 7, and have a depth of 2 in the tree hierarchy depicted in FIG. 6A, such that the “Name” context paths 615A and 620A are indexed as (40,3,8,2) and (40,11,16,2) in Table 8.

When a node stores a value, the value itself can have its own index. Accordingly, the value of “Brown” 650A as shown in FIG. 6A is part of document 40, start at location 6 and ends at location 7 as shown in Table 7, and has a depth of 3 (i.e., the depth of the node that stores the associated value of “Brown”) in the tree hierarchy depicted in FIG. 6A, such that the “Brown” value 650A is indexed as (40,6,7,3) in Table 8. The value of “Paddon” 660A as shown in FIG. 6A is part of document 40, start at location 14 and ends at location 15 as shown in Table 7, and has a depth of 3 (i.e., the depth of the node that stores the associated value of “Paddon”) in the tree hierarchy depicted in FIG. 6A, such that the “Paddon” value 660A is indexed as (40,14,15,3) in Table 8.

The flat-indexing protocol uses a brute-force approach to resolve paths. In an XML-specific example, an XPath query for /Patent/Inventor/Name/Last would require separate searches to each node in the address (i.e., “Patent”, “Inventor”, “Name” and “Last”), with the results of each query being joined with the results of each other query, as follows:

TABLE 9
Example of XPath Query for a Flat-Indexed Database

joinChild(

joinChild(

joinChild(

lookup(Patent),
lookup(Inventor)),

lookup(Name)),

lookup(Last))

Label-path indexing is described in a publication by Goldman et al. entitled “DataGuides: Enabling Query Formulation and Optimization in Semistructured Databases”. Generally, label-path indexing is an alternative to flat-indexing, whereby the path to the target node is indexed in place of the node identifier of the flat-indexing protocol, as follows:

TABLE 10
Example of XML-based Tree Hierarchy Shown in FIG. 6A

<Patent>_{A}¹

<Inventor>_{B}²

<Name>_{C}³

<First>_{D}⁴Craig</First>⁵
<Last>_{E}⁶Brown</Last>⁷

</Name>⁸

</Inventor>⁹
<Examiner>_{F}¹⁰

<Name>_{G}¹¹

<First>_{H}¹²Michael</First>¹³
<Last>_{I}¹⁴Paddon</Last>¹⁵

</Name>¹⁶

</Examiner>¹⁷

</Patent>¹⁸

whereby each number represents a location of the document structure that can be used to defined the respective node range, and each letter label (A through I) identifies a context path to a particular node or value, as shown in Table 11 as follows:

TABLE 11
Example of Label-Path Indexing of
Nodes of FIG. 6A Based on Table 10

| Context Path, Node or Value | Docid, Start, End, Depth |
|---|---|
| B (/Patent/Inventor) | (40, 2, 9, 1) |
| C (/Patent/Inventor/Name) | (40, 3, 8, 2) |
| E (/Patent/Inventor/Name/Last), Brown | (40, 6, 7, 3) |
| H(/Patent/Examiner/Name/First), Michael | (40, 12, 13, 3) |

Accordingly, with respect to Tables 10-11, the “Inventor” node 605A of FIG. 6A at the context path /Patent/Inventor (or context path B) is part of document 40, starts at location 2 and ends at location 9 as shown in Table 10, and has a depth of 1 in the tree hierarchy depicted in FIG. 6A, such that the “Inventor” context path 605A is indexed as (40,2,9,1) in Table 11. The “Name” context path 615A of FIG. 6A at the context path /Patent/Inventor/Name (or context path C) is part of document 40, starts at location 3 and ends at location 8 as shown in Table 10, and has a depth of 2 in the tree hierarchy depicted in FIG. 6A, such that the “Name” context path 615A is indexed as (40,3,8,2) in Table 11. The “Brown” value 650A of FIG. 6A at the context path /Patent/Inventor/Name/Last (or context path E) is part of document 40, starts at location 6 and ends at location 7 as shown in Table 10, and has a depth of 3 (i.e., the depth of the node that stores the “Brown” value 650A) in the tree hierarchy depicted in FIG. 6A, such that the “Brown” value 650A is indexed as (40,6,7,3) in Table 11. The “Michael” value 655A of FIG. 6A at the context path /Patent/Examiner/Name/First (or context path H) is part of document 40, starts at location 12 and ends at location 13 as shown in Table 10, and has a depth of 3 (i.e., the depth of the node that stores the “Michael” value 655A) in the tree hierarchy depicted in FIG. 6A, such that the “Michael” value 655A is indexed as (40,12,13,3) in Table 11.

More detailed XML descriptions will now be provided. At the outset, certain XML terminology is defined as follows:
Byte Offset: Byte count from the start of a file. In certain embodiments of this disclosure, it is assumed that one character is equal to one byte, but it will be appreciated by one of ordinary skill in the art this is simply for convenience of explanation and that multi-byte characters such as those used in foreign languages could also be handled in other embodiments of this disclosure.
Context ID: A unique ID for a context path. In certain embodiments of this disclosure, the Context ID is indicated via a single capital letter.
Node ID: Start byte offset, end byte offset, and depth uniquely identifying a node within a document.
Document ID/Doc ID: Identifier uniquely identifying an XML document index.
Context Path Element Index: Index where the index key contains a Context ID. Used for elements that contain both simple and complex content, where simple content means the element contains text only and complex content means elements contain other elements or a mixture or text and elements. The index value contains a Doc ID/Node ID pair.
Context Path Simple Content Index: Index where the index key contains a Context ID and a value. The index value contains a Doc ID/Node ID pair.
Flat Element Index: Index where the index key contains a node name. Used for elements that contain both simple and complex content. The index value contains a Doc ID/Node ID pair.
Flat Simple Context Index: Index where the index key contains a node name and a value. The index value contains a Doc ID/Node ID pair.
Path Instance: The route from the top of a document down to a specific node within the document.
Posting: Doc ID/Node ID tuple uniquely identifying a node within a database.
XML Document: A single well-formed XML document.

In Table 9 with respect to the flat-indexed protocol, it will be appreciated that the XPath query directed to /Patent/Inventor/Name/Last required four separate lookups for each of the nodes “Patent”, “Inventor”, “Name” and “Last”, along with three joins on the respective lookup results. By contrast, a similar XPath query directed to /Patent/Inventor/Name/Last using the label-path indexing depicted in Tables 10-11 would have a compiled query of lookup(E) based on the path /Patent/Inventor/Name/Last being defined as path “E”.

Generally, the label-path indexing protocol is more efficient for databases with a relatively low number of context paths for a given node name (e.g., less than a threshold such as 100), with the flat-indexing protocol overtaking the label-path indexing protocol in terms of query execution time as the number of context paths increases.

A number of different example XML document structures are depicted below in Table 12 including start and end byte offsets:

TABLE 12
XML Document Examples with Start and End Byte Offsets

Document 1
<Document>_{A}⁰
<Inventor>_{E}¹⁶

<FirstName>_{J}³⁵Craig</FirstName>⁶³
<LastName>_{K}⁷²Brown</LastName>⁹⁸

```
  </Inventor>¹¹⁴
  <Inventor>_{E}¹¹⁹
```

<FirstName>_{J}¹³⁸Xavier</FirstName>¹⁶⁷
<LastName>_{K}¹⁷⁶Franc</LastName>²⁰²

```
  </Inventor>²¹⁸
  <Examiner>_{F}²²³
```

<FirstName>_{L}²⁴²Michael</FirstName>²⁷²
<LastName>_{M}²⁸¹Paddon</LastName>³⁰⁸

```
  </Examiner>³²⁴
</Document>³³⁶
Document 2
<searchResponse>_{N}⁰
  <attr ²⁸name_{P} =”uid”³⁸> _{O} ²²
```

<Value>_{Q}⁴⁸one</Value>⁶⁶

```
  </attr>⁷⁸
  <attr⁸⁹name_{P}=”name”¹⁰⁰>_{O}¹¹⁰
```

<Value>_{Q}¹¹⁰Mr One</Value>¹³¹

```
  </attr>¹⁴³
</searchResponse>¹⁶¹
Document 3
<other>_{R}⁰
  <searchResponse>_{S}¹³
```

<attr⁴⁴name_{U}=”uid”⁵⁴>_{T}³⁸
<Flag>_{V}⁶⁸True</Flag>⁸⁵
</attr>¹⁰¹

```
  </searchResponse>¹²³
</other>¹³²
Document 4
<more>_{W}⁰
  <searchResponse>_{X}¹²
```

```
<attr ⁴³name_{Z}=”uid” ⁵³>_{Y}³⁷
  <Value>_{AA}⁶⁷two</Value>⁸⁵
</attr>¹⁰¹
<attr¹¹⁶name_{Z}=”name” ¹²⁷>_{Y}¹¹⁰
  <Value>_{AA}¹⁴¹Mr Two</Value>¹⁶²
</attr>¹⁷⁸
```

</searchResponse>²⁰⁰
</more>²⁰⁸

whereby each number represents a location of the document structure that can be used to defined the respective node range, and each letter label identifies a context path to a particular node or value as depicted in FIG. 6C (described below in more detail).

Next, a flat simple content index for the documents depicted in Table 12 is as follows:

TABLE 13
Flat Simple Content Index

| Name, Value | Doc ID, Start, End, Depth |
|---|---|
| FirstName, Craig | 1, 35, 63, 2 |
| LastName, Brown | 1, 72, 98, 2 |
| FirstName, Xavier | 1, 138, 167, 2 |
| LastName, Franc | 1, 176, 202, 2 |
| FirstName, Michael | 1, 242, 272, 2 |
| LastName, Paddon | 1, 281, 308, 2 |
| @name, uid | 2, 28, 38, 2 |
| | 3, 44, 54, 3 |
| | 4, 43, 53, 3 |
| Value, one | 2, 48, 66, 2 |
| Value, two | 4, 67, 85, 3 |
| @name, name | 2, 89, 100, 2 |
| | 4, 116, 127, 3 |
| Value, Mr One | 2, 110, 131, 2 |
| Value, Mr Two | 4, 141, 162, 3 |
| Flag, True | 3, 68, 85, 3 |

Next, a flat element index for the documents depicted in Table 12 is as follows,

TABLE 14
Flat Element Index

| Name | Doc ID, Start, End, Depth |
|---|---|
| document | 1, 0, 336, 0 |
| Inventor | 1, 16, 114, 1 |
| | 1, 119, 218, 1 |
| FirstName | 1, 35, 63, 2 |
| | 1, 138, 167, 2 |
| | 1, 242, 272, 2 |
| LastName | 1, 72, 98, 2 |
| | 1, 176, 202, 2 |
| | 1, 281, 308, 2 |
| Examiner | 1, 223, 324, 1 |
| searchResponse | 2, 0, 161, 0 |
| | 3, 13, 123, 1 |
| | 4, 12, 200, 1 |
| other | 3, 0, 132, 0 |
| more | 4, 0, 208, 0 |
| @name | 2, 28, 38, 2 |
| | 3, 44, 54, 3 |
| | 4, 43, 53, 3 |
| | 2, 89, 100, 2 |
| | 4, 116, 127, 3 |
| Value | 2, 48, 66, 2 |
| | 2, 110, 131, 2 |
| | 4, 67, 85, 3 |
| | 4, 141, 162, 3 |
| Flag | 3, 68, 85, 3 |

FIG. 6B illustrates an annotated version of Table 13, including examples of a document identifier 600B (e.g., “1” for document 1 of Table 12), a node identifier 605B (e.g., 138,167,2, to denote the start byte, end byte and depth of a particular node, respectively), an index value 610B (e.g., a combination of document identifier, and index value), an index key 615B (e.g., “FirstName:Xavier”), an index entry 620B (e.g., a combination of index key and each associated index value) and a posting 625B (e.g., one of a plurality of document identifier and node identifier combinations for a particular index entry).

FIG. 6C illustrates a context tree 600C with labeled context paths based on the documents depicted above in Table 12, and further based on the context tree simple content index depicted below in Table 15 and the context tree element index depicted below in Table 16:

TABLE 15
Context Tree Simple Content Index

| Context ID, Value | Doc ID, Start, End, Depth |
|---|---|
| J, Craig | 1, 35, 63, 2 |
| K, Brown | 1, 72, 98, 2 |
| J, Xavier | 1, 138, 167, 2 |
| K, Franc | 1, 176, 202, 2 |
| L, Michael | 1, 242, 272, 2 |
| M, Paddon | 1, 281, 308, 2 |
| P, uid | 2, 28, 38, 2 |
| U, uid | 3, 44, 54, 3 |
| Z, uid | 4, 43, 53, 3 |
| Q, one | 2, 48, 66, 2 |
| AA, two | 4, 67, 85, 3 |
| P, name | 2, 89, 100, 2 |
| Z, name | 4, 116, 127, 3 |
| Q, Mr One | 2, 110, 131, 2 |
| AA, Mr Two | 4, 141, 162, 3 |
| V, True | 3, 68, 85, 3 |

TABLE 16
Context Tree Element Index

| Name | Doc ID, Start, End, Depth |
|---|---|
| A | 1, 0, 336, 0 |
| E | 1, 16, 114, 1 |
| | 1, 119, 218, 1 |
| J | 1, 35, 63, 2 |
| | 1, 138, 167, 2 |
| L | 1, 242, 272, 2 |
| K | 1, 72, 98, 2 |
| | 1, 176, 202, 2 |
| M | 1, 281, 308, 2 |
| F | 1, 223, 324, 1 |
| N | 2, 0, 161, 0 |
| S | 3, 13, 123, 1 |
| X | 4, 12, 200, 1 |
| R | 3, 0, 132, 0 |
| W | 4, 0, 208, 0 |
| P | 2, 28, 38, 2 |
| | 2, 89, 100, 2 |
| U | 3, 44, 54, 3 |
| Z | 4, 43, 53, 3 |
| | 4, 116, 127, 3 |
| O | 2, 48, 66, 2 |
| | 2, 110, 131, 2 |
| AA | 4, 67, 85, 3 |
| | 4, 141, 162, 3 |
| V | 3, 68, 85, 3 |

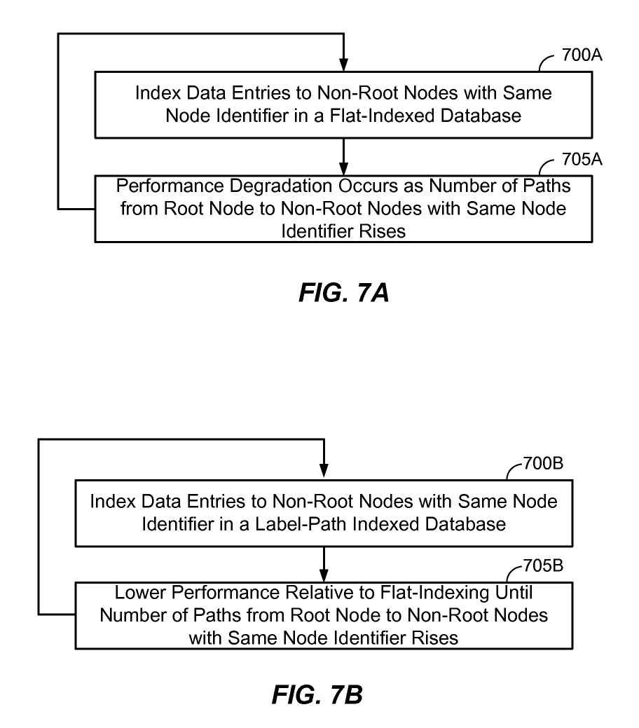

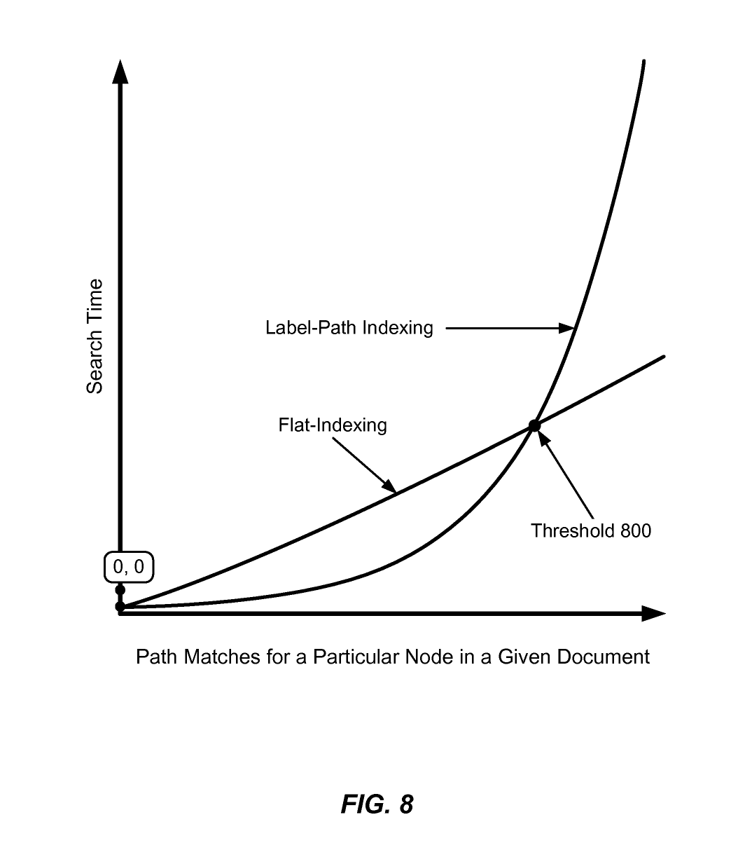

FIG. 7A illustrates an example procedure of adding (or indexing) new data entries into a flat-indexed, semi-structured database that is maintained at the semi-structured database server 170 in accordance with a flat-indexing protocol. Referring to FIG. 7A, the semi-structured database server 170 obtains and indexes new data entries to non-root nodes (creating new node contexts as necessary) with the same node identifier in the flat-indexed database in accordance with the flat-indexing protocol, in block 700A. The indexing in block 700A may cause a number of paths from a root node of a given document in the flat-indexed database to non-root nodes with the same node identifier to increase. For example, non-root nodes 615C and 620C have the same identifier (i.e., “Name”), so the number of paths from the root node (i.e., root node “Patent” 600C) to non-root nodes identified as “Name” is two.

In block 705A, performance degradation in the flat-indexed database may occur as the number of paths from the root node to non-root nodes sharing the same node identifier increases due to the indexing in block 700A. For example, the performance degradation in block 705A may include higher search times for nodes sharing the same node identifier in the given document. Despite the experienced degradation, because the database is being indexed using a flat-indexed database, the semi-structured database server 170 continues to obtain and index new data entries to non-root nodes (creating new node contexts as necessary) with the same node identifier in the flat-indexed database, in block 700A.

FIG. 7B illustrates an example procedure of adding (or indexing) new data entries into a label-path indexed, semi-structured database that is maintained at the semi-structured database server 170 in accordance with a label-path indexing protocol. Referring to FIG. 7B, the semi-structured database server 170 obtains and indexes new data entries to non-root nodes (creating new node contexts as necessary) with the same node identifier in the label-path indexed database in accordance with the label-path indexing protocol, in block 700B. With respect to a label-path indexed database of FIG. 7B, the label-path indexed database experiences lower performance (e.g., longer search times, etc.) relative to a flat-indexed database while a number of paths from a root node of a given document in the label-path indexed database to non-root nodes with the same node identifier is relatively low, or until the number rises to a certain level. The semi-structured database server 170 continues to obtain and index new data entries to non-root nodes (creating new node contexts as necessary) with the same node identifier in the label-path indexed database in accordance with the label-path indexing protocol, in block 700B, as the number of paths from the root node of the given document to non-root nodes with the same identifier increases.

As will be appreciated by one of ordinary skill in the art in view of FIG. 8, the label-path indexing protocol and the flat-indexing protocol are associated with different advantages and disadvantages. In particular, as shown in FIG. 8, the label-path indexing protocol is associated with lower search times when the number of unique paths to nodes with the same node identifier is relatively low, while the flat-indexing protocol is associated with lower search times when the number of unique paths to nodes with the same node identifier is relatively high. As shown in FIG. 8, label-path indexing becomes exponentially less efficient as the path-number to same-identified nodes increases, while flat-indexing scales in a more linear fashion.

Embodiments of the disclosure are thereby directed to adding (or indexing) new data entries into a semi-structured database that is maintained at the semi-structured database server 170 in a manner that leverages the different advantages and disadvantages associated with the label-path indexing protocol and the flat-indexing protocol. For example, various embodiments are directed to a selective indexing method implementing the flat-indexing protocol and/or the label-path indexing protocol in a selective manner based on the number of unique paths to nodes with the same node identifier in a particular document in a semi-structured database. In one example, a threshold number of unique paths to nodes with the same node identifier in a particular document in a semi-structured database may be determined. The threshold may be the point below which the label-path indexing protocol is associated with lower search times for same-identified nodes in the given document and above which the flat-indexed protocol is associated with lower search times for same-identified nodes in the given document, as depicted in FIG. 8 as threshold 800. In an example, the threshold 800 can be established based on empirical study, and can potentially vary from document to document based on a number of system-specific factors or document-specific factors. For example, the threshold 800 can be adjusted based on index size (e.g., maintaining the node hierarchy at a certain value in terms of total number of nodes and/or in terms of tree-depth or nesting level may be more beneficial than arbitrarily picking a value such as 200 for the threshold).

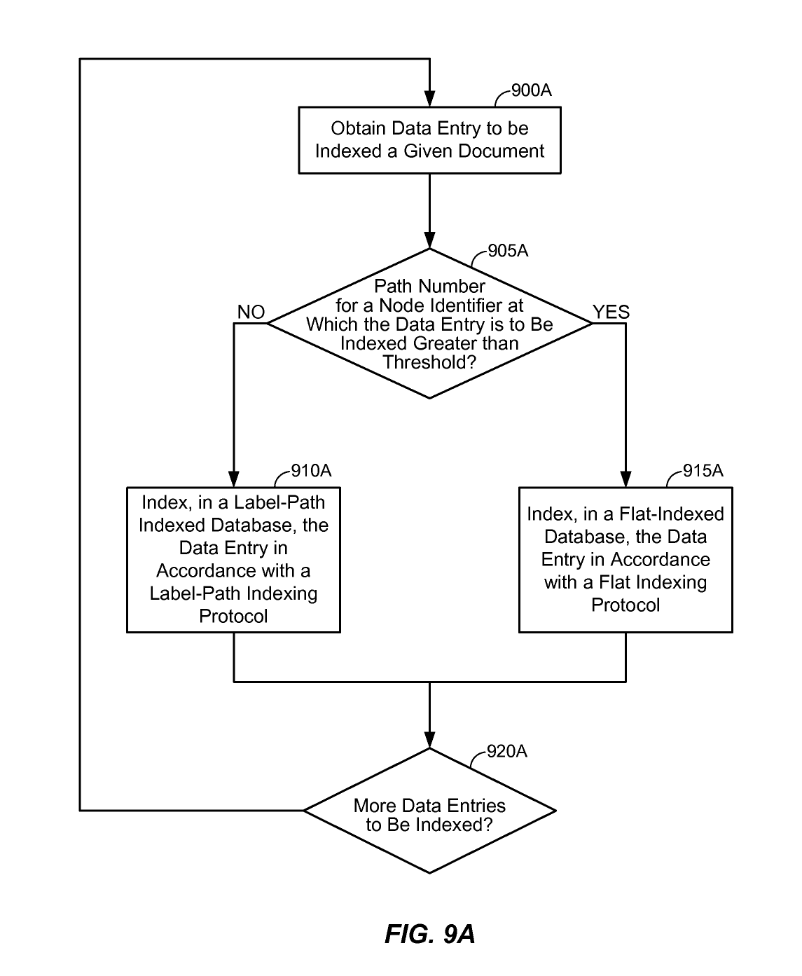

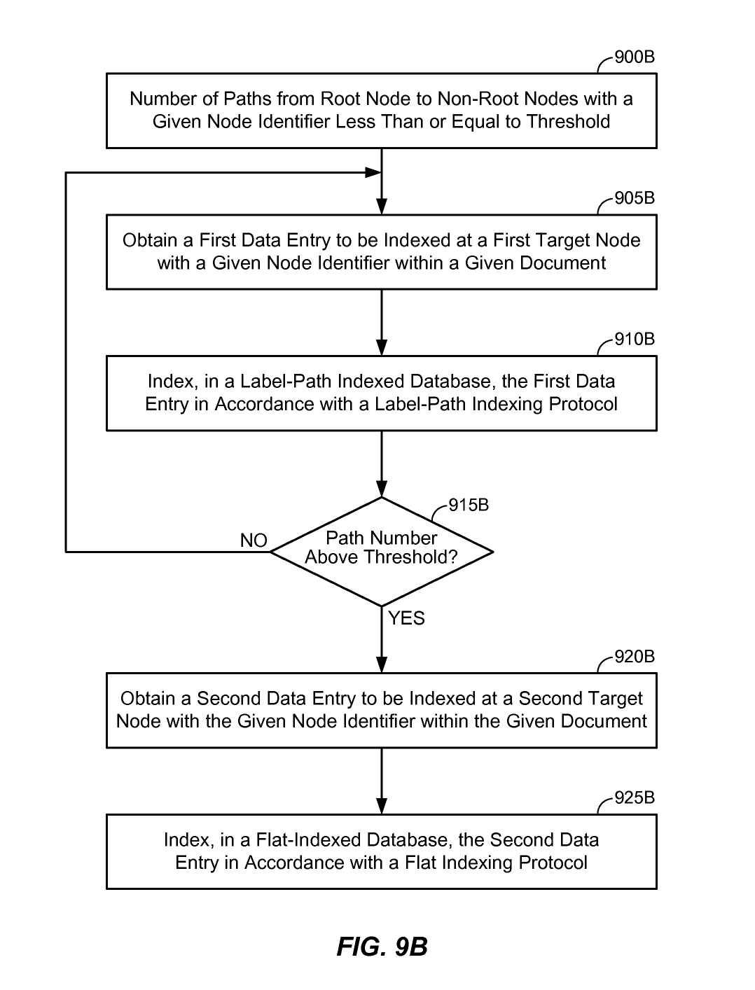

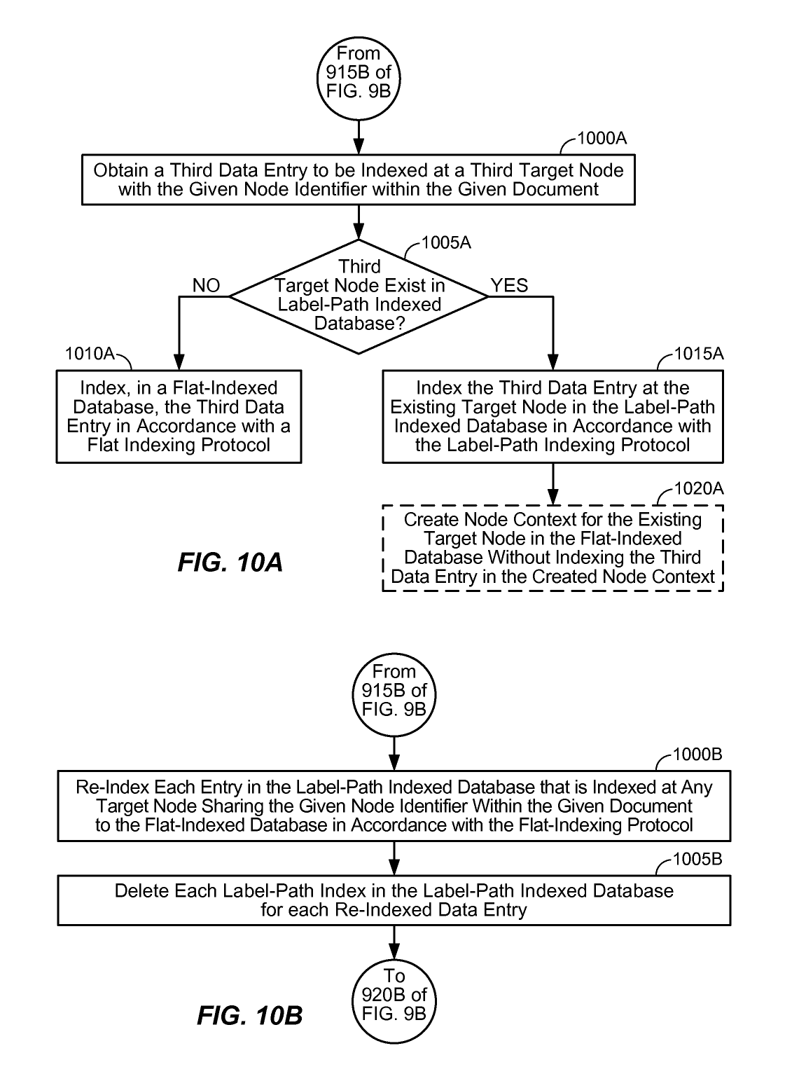

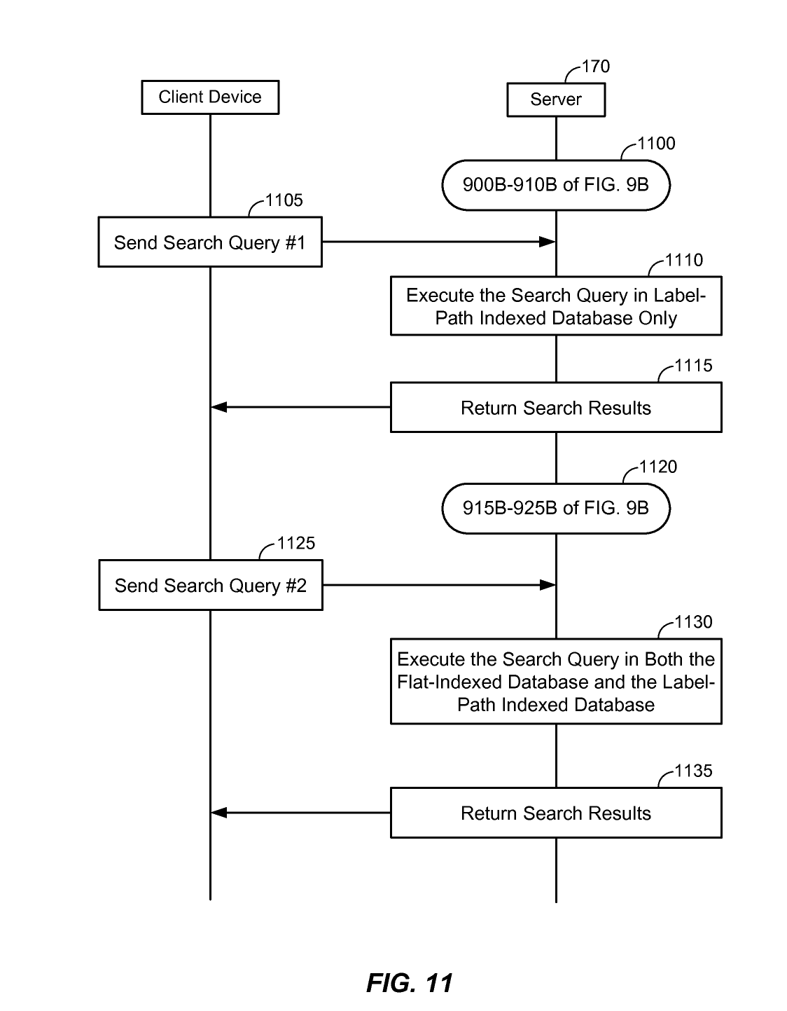

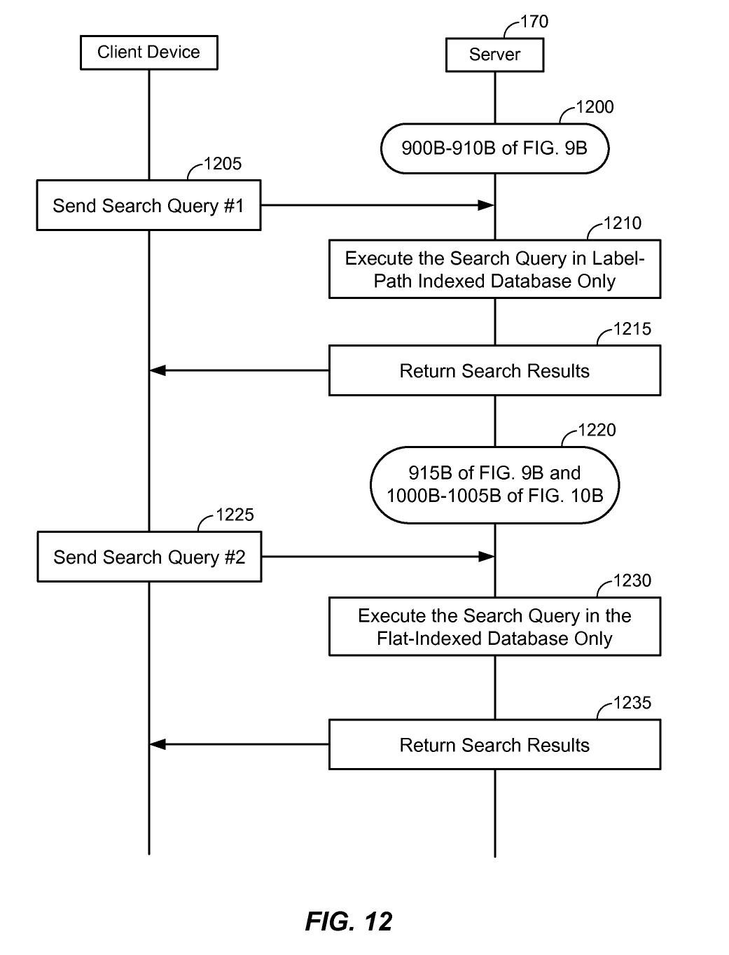

FIG. 9A is directed to a process of indexing data entries in a semi-structured database that is maintained at the semi-structured database server 170 in accordance with an embodiment of the disclosure. Referring to FIG. 9A, the semi-structured database server 170 obtains a data entry to be indexed in a given document, in block 900A. Moreover, in block 900A, the semi-structured database server 170 determines that the data entry is to be indexed at a particular non-root node of the given document. In block 905A, the semi-structured database server 170 determines whether a number of paths (“path number”) from a root node of the given document to non-root nodes sharing a node identifier with the particular non-root node is greater than a threshold. For example, the threshold referred to with respect to block 905A of FIG. 9A can correspond to the threshold 800 described above with respect to FIG. 8. In an example, a node identifier determined to have a path number above the threshold at block 905A may be characterized as a pathological node.

Referring to FIG. 9A, if the semi-structured database server 170 determines that the path number for the node identifier is not greater than the threshold, the semi-structured database server 170 indexes the data entry in a label-path indexed database in accordance with the label-path indexing protocol, in block 910A. Otherwise, if the semi-structured database server 170 determines that the path number for the node identifier is greater than the threshold, the semi-structured database server 170 indexes the data entry in a flat-indexed database that is separate from the label-path indexed database in accordance with the flat-indexing protocol, in block 915A. In block 920A, if the semi-structured database server 170 obtains one or more additional data entries to be indexed, the process returns to block 900A.

With respect to FIG. 9A, it will be appreciated that, over time, nodes may become pathological which triggers a YES evaluation at block 905A, resulting in the flat-indexing operation in block 915A. However, while some nodes may become pathological, other nodes may remain normal in the sense that the number of nodes sharing a particular node identifier remains less than or equal to the threshold. Accordingly, execution of the process of FIG. 9A can result in the evaluation in block 905A being different for different nodes based on node-specific path numbers.

FIG. 9B illustrates an example implementation of the process of FIG. 9A in accordance with an embodiment of the disclosure. In particular, FIG. 9B depicts a scenario where a path number for a particular node identifier rises above the threshold described above with respect to block 905A of FIG. 9A. Referring to FIG. 9B, in an example, the semi-structured database server 170 may start indexing data entries in a particular document via the label-path indexing protocol in a label-path indexed database while tracking, for each node identifier, a number of paths from a root node to non-root nodes with the same node identifier. At block 900B, in an example, the number of paths from the root node to the non-root nodes that each share a given node identifier (e.g., “Name”, “FirstName”, etc.) in the label-path indexed database is less than or equal to a threshold. For example, the threshold referred to with respect to block 900B of FIG. 9B can correspond to the threshold 800 described above with respect to FIG. 8.

The semi-structured database server 170 obtains and indexes new data entries to non-root (or target) nodes (creating new node contexts as necessary) with the given node identifier in the label-path indexed database in accordance with the label-path indexing protocol, in blocks 905B and 910B (e.g., as in blocks 905A and 910A of FIG. 9A). In particular, in block 905B, the semi-structured database server 170 obtains a first data entry to be indexed at a first target node with the given node identifier within the given document, and the semi-structured database server 170 then indexes the first data entry in the label-path indexed database in accordance with the label-path indexing protocol in block 910B.

As each new data entry is indexed at a node sharing the given node identifier in block 910B, the semi-structured database server 170 evaluates whether the path number for the given node identifier (i.e., the number of paths from the root node of the given document to non-root nodes with the given node identifier) in the label-path indexed database has risen above the threshold, in block 915B. If the semi-structured database server 170 determines that the path number for the given node identifier remains equal to or less than the threshold at block 915B, the process returns to block 905B and the semi-structured database server 170 continues to index new data entries to be indexed at nodes sharing the given node identifier in the label-path indexed database for the given document using the label-path indexing protocol. Otherwise, if the semi-structured database server 170 determines that the path number for the given node identifier is above the threshold at block 915B, the semi-structured database server 170 begins to index new data entries to be indexed at nodes sharing the given node identifier via the flat-indexing protocol in a flat-indexed database that is separate from the label-path indexed database. In particular, in block 920B, the semi-structured database server 170 obtains a second data entry to be indexed at a second target node (which may be the same or different from the first target node) with the given node identifier within the given document, and the semi-structured database server 170 then indexes the second data entry in the flat-indexed database in accordance with the flat-indexing protocol in block 925B. As noted above, a node identifier determined to have a path number above the threshold at block 915B may be characterized as a pathological node.

While not shown expressly in FIG. 9B, it will be appreciated that the given node identifier becoming pathological at block 915B, which triggers the flat-indexing operations of blocks 920B and 925B, need not affect other non-pathological nodes. Accordingly, new data entries to non-pathological nodes (e.g., nodes associated with a path number that is not above the threshold) may continue to be indexed via the label-path indexing protocol, and queries directed to non-pathological nodes may likewise be implemented with respect to the label-path indexed database, even after block 915B determines the given node identifier to be pathological.

In FIGS. 9A-9B, it is possible that the node contexts for nodes sharing the given node identifier are maintained in the label-path indexed database even after the evaluation in block 905A and/or in block 915B of FIG. B determines that the path number for the given node identifier in the given document exceeds the threshold. This is shown in FIG. 10A, which illustrates a continuation of the process of FIG. 9B in accordance with an embodiment of the disclosure.

Referring to FIG. 10A, the semi-structured database server 170 obtains a third data entry (e.g., either before or after the second data entry is obtained and indexed at blocks 920B-925B) to be indexed at a third target node (which may be the same or different from the first and/or second target nodes) with the given node identifier within the given document, in block 1000A. In the embodiment of FIG. 10A, the semi-structured database server 170 determines whether the third target node is a legacy node that has a node context which is already part of the label-path indexed database, in block 1005A. If not, then the third data entry is indexed in the flat-indexed database with the flat-indexing protocol, in block 1010A, similar to block 925B of FIG. 9B. However, if the third target node is a legacy node that has a node context which is already part of the label-path indexed database, then the semi-structured database server 170 indexes the third data entry at the legacy node in the label-path indexed database in accordance with the label-path indexing protocol, in block 1015A. In an example, the semi-structured database server 170 may also create a node context for the legacy node in the flat-indexing database as well, in block 1020A. However, the third data entry itself is not indexed into the created node context within the flat-indexed database because, in this instance, the third data entry has already been indexed into the legacy node of the label-path indexed database.

While FIG. 10A is directed to an example implementation whereby legacy nodes for the given node identifier in the label-path indexed database are retained in conjunction with indexing via the flat-indexing protocol after block 915B, it is also possible to re-index (or transfer) the legacy nodes into the flat-indexed database, as discussed below with respect to FIG. 10B.

Referring to FIG. 10B, after determining that the path number for the given node identifier in the label-path indexed database is above the threshold at block 915B of FIG. 9B, the semi-structured database server 170 re-indexes each entry in the label-path indexed database that is indexed at any target node sharing the given node identifier within the given document to the flat-indexed database in accordance with the flat-indexing protocol, in block 1000B. After the re-indexing, the data entries and their associated node contexts (or nodes) in the label-path indexed database are deleted or removed, in block 1005B. For example, using the patent database example from FIG. 6A, if the number of “FirstName” nodes rises above the threshold in the label-path indexed database, the “FirstName” nodes may be added to the flat-indexed database and then removed from the label-path indexed database, resulting in the label-path indexed database including no nodes named “FirstName” and none of the previous data entries that were stored in the respective “FirstName” nodes.

FIG. 11 illustrates a process of executing a series of search queries during the process of FIG. 9B in accordance with an embodiment of the disclosure. Referring to FIG. 9B, in an example, the semi-structured database server 170 executes blocks 900B-910B of FIG. 9B, in block 1100, after which a given client device sends a first search query to the semi-structured database server 170, in block 1105. In an example, the first search query may require the given document to be searched, and the flat-indexed database for the given document may not yet be generated for any nodes. In this example, the semi-structured database server 170 executes the search query in the label-path indexed database only for the given document, in block 1110, and returns any search results to the given client device, in block 1115. Later, the semi-structured database server 170 executes blocks 915B-925B for at least one set of node identifiers, such that the flat-indexed database is created. At this point, the given client device sends a second search query to the semi-structured database server 170, in block 1125. In an example, the second search query may search for node names that are indexed in the flat-indexed database. In this example, the semi-structured database server 170 executes the search query for the given document in both the label-path indexed database and the flat-indexed database, in block 1130, and returns any search results to the given client device, in block 1135.

FIG. 12 illustrates another process of executing a series of search queries during the process of FIG. 9B in accordance with an alternative embodiment of the disclosure. Referring to FIG. 12, blocks 1200-1215 correspond to blocks 1100-1115 and will not be described further for the sake of brevity. At block 1220, block 915B of FIG. 9B and blocks 1000B-1005B of FIG. 10B are executed. Accordingly, after in block 1220, each data entry at each node with the given node identifier is removed from the label-path indexed database and moved (or re-indexed) into the flat-indexing database. At this point, the given client device sends a second search query to the semi-structured database server 170, in block 1225. In an example, the second search query may search for node names that are indexed in the flat-indexed database. In this example, the semi-structured database server 170 executes the search query for the given document in the flat-indexed database because the target node(s) sharing the given node identifier are no longer part of the label-path indexed database, in block 1230, and returns any search results to the given client device, in block 1235. In an example, during both indexing and querying, the semi-structured database server 170 maintains a count of the contexts discovered for any given node. In an example, this context count can be kept along with the label-path index. Accordingly, for each query, the context count can be analyzed to determine whether the query is to be executed in association with the label-path indexed database, the label-path indexed database, or both.

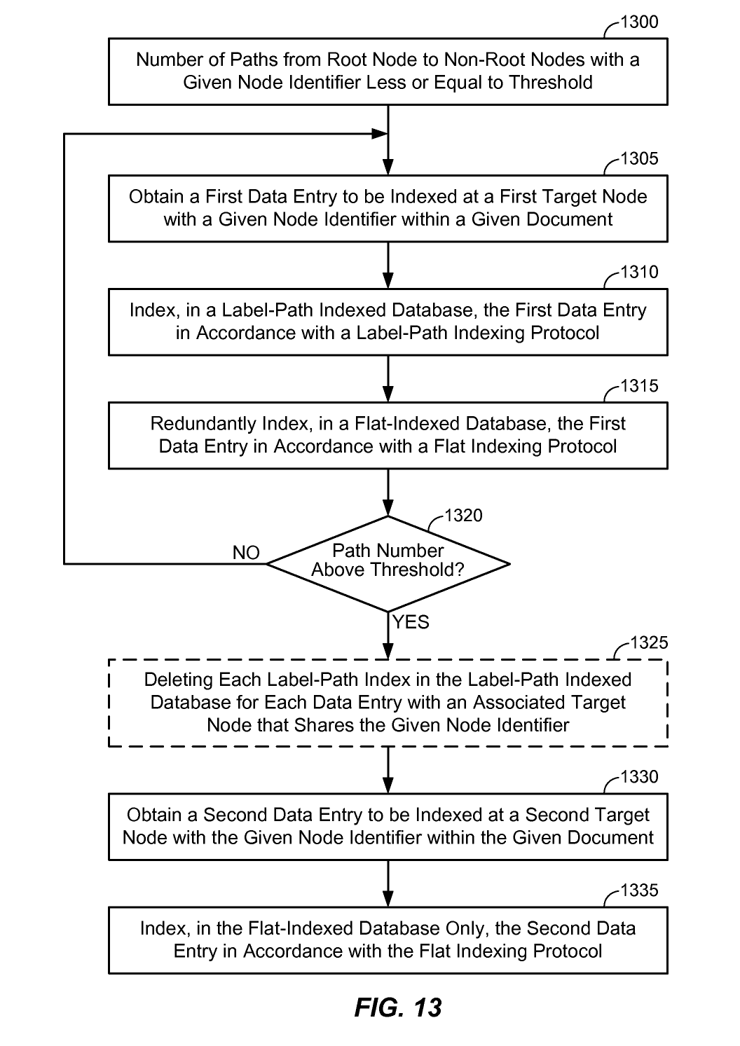

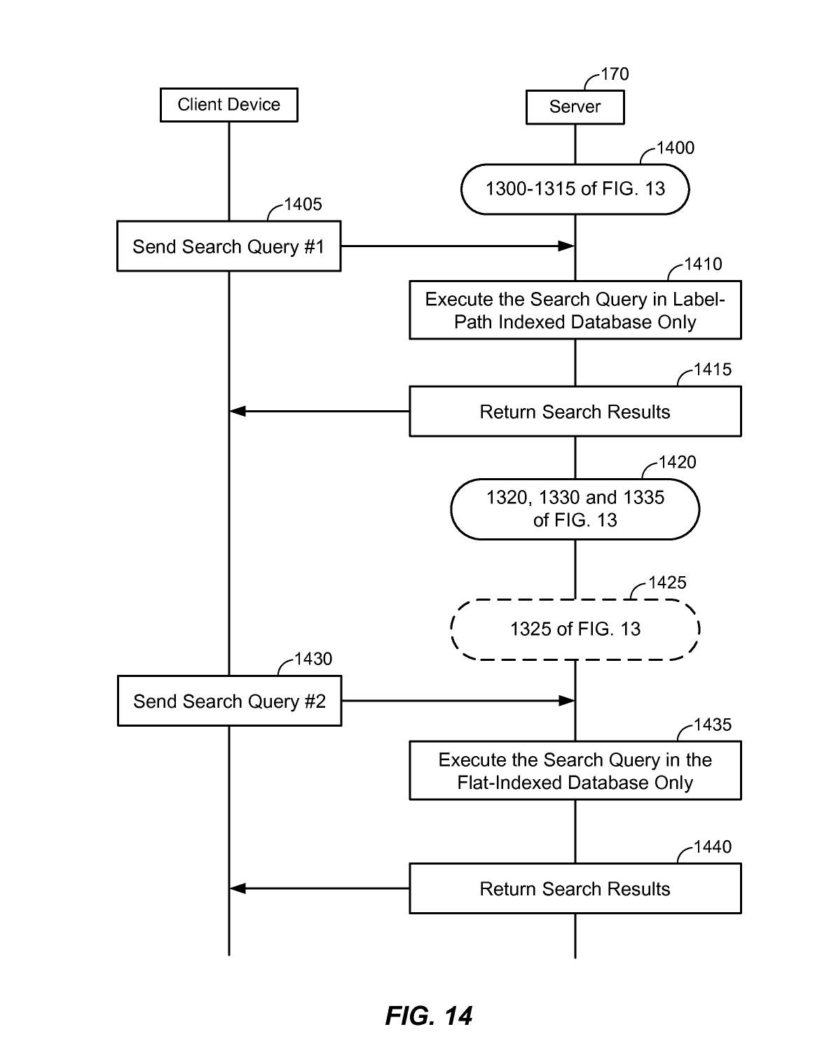

FIG. 13 is directed to a process of indexing data entries in a semi-structured database that is maintained at the semi-structured database server 170 in accordance with another embodiment of the disclosure. Referring to FIG. 13, in an example, the semi-structured database server 170 may start indexing data entries in a particular document redundantly via both the flat-indexing protocol in a flat-indexed database and the label-path indexing protocol in a label-path indexed database while tracking, for each node identifier, a number of paths from a root node to non-root nodes with the same node identifier. At block 1300, in an example, the number of paths from the root node to non-root nodes that each share a given node identifier (e.g., “Name”, “FirstName”, etc.) in the label-path indexed database may be less than or equal to a threshold. For example, the threshold referred to with respect to block 1300 of FIG. 13 can correspond to the threshold 800 described above with respect to FIG. 8.

At least while the path number remains less than or equal to the threshold, the semi-structured database server 170 obtains and indexes new data entries to non-root (or target) nodes (creating new node contexts as necessary) with the given node identifier redundantly in both the label-path indexed database in accordance with the label-path indexing protocol and the flat-indexed database in accordance with the flat-indexing protocol, in blocks 1305, 1310, and 1315. In particular, the semi-structured database server 170 obtains a first data entry to be indexed at a first target node with the given node identifier within the given document, in block 1305, the semi-structured database server 170 indexes the first data entry in the label-path indexed database in accordance with the label-path indexing protocol, in block 1310 and the semi-structured database server 170 also indexes the first data entry in the flat-indexed database in accordance with the flat-indexing protocol, in block 1315.

As each new data entry is indexed at blocks 1310 and 1315, the semi-structured database server 170 evaluates whether the path number for the given node identifier (i.e., the number of paths from the root node of the given document to non-root nodes with the given node identifier) in the label-path indexed database has risen above the threshold, in block 1320. If the semi-structured database server 170 determines that the path number is equal to or less than the threshold at block 1320, the process returns to block 1305 and the semi-structured database server 170 continues to index new data entries redundantly in both the label-path indexed database and flat-indexed database for the given document, in blocks 1310-1315. Otherwise, in an example, if the semi-structured database server 170 determines that the path number is above the threshold at block 1320, the semi-structured database server 170 may purge (or delete) the label-path indexed database of each label-path index related to the nodes sharing the given node identifier, in block 1325. In an example, if block 1325 is performed, then any queries performed thereafter directed to the given node identifier will be performed exclusively with respect to the flat-indexed database despite the earlier redundant indexing.

Irrespective of whether the data entries for the given node identifier and associated node contexts are purged at block 1325, the semi-structured database server 170 continues to index new data entries via the flat-indexing protocol in the flat-indexed database only. In particular, the semi-structured database server 170 obtains a second data entry to be indexed at a second target node (which may be the same or different from the first target node) with the given node identifier within the given document, in block 1330, and the semi-structured database server 170 then indexes the second data entry in the flat-indexed database in accordance with the flat-indexing protocol, in block 1335. Accordingly, even if the label-path indexed database retains the redundant indexes associated with the given node identifier from blocks 1300-1320, any new indexing for the given node identifier occurs in the flat-indexed database only after the path number exceeds the threshold (e.g., although it is possible that legacy nodes that were already a part of the label-path indexed database are still updated in a redundant manner with new data entries, somewhat similar to the process of FIG. 10A).

With respect to FIG. 13, it will be appreciated that, over time, nodes may become pathological which triggers a YES evaluation at block 1320, resulting in the flat-indexing in blocks 1330-1335. However, while some nodes may become pathological, other nodes may remain normal in the sense that the number of nodes sharing a particular node identifier remains less than or equal to the threshold. Accordingly, execution of the process of FIG. 13 can result in the evaluation of block 1320 being different for different nodes based on node-specific path numbers. In other words, while not shown expressly in FIG. 13, it will be appreciated that the given node identifier becoming pathological at block 1320, which triggers the flat-indexing in blocks 1330-1335, need not affect other non-pathological nodes. Accordingly, new data entries to non-pathological nodes (e.g., nodes associated with a path number that is not above the threshold) may continue to be indexed via the label-path indexing protocol, and queries directed to non-pathological nodes may likewise be implemented with respect to the label-path indexed database, even after block 1320 determines the given node identifier to be pathological.

FIG. 14 illustrates a process of executing a series of search queries during the process of FIG. 13 in accordance with an embodiment of the disclosure. Referring to FIG. 14, in an example, the semi-structured database server 170 executes blocks 1300-1315 of FIG. 13, in block 1400, after which a given client device sends a first search query to the semi-structured database server 170, in block 1405. In an example, the first search query may require the given document to be searched (e.g., by specifying a particular target node name for the query). The semi-structured database server 170 has the option to choose either the label-indexed database or the flat-indexed database for execution of the search query, since both respective databases have redundantly indexed each data entry up to this point. However, the label-path indexed database is expected to be faster when the path number is lower than the threshold, so in an example, the semi-structured database server 170 may opt to execute the search query with respect to the label-path indexed database only in block 1410, after which the semi-structured database server 170 returns any search results to the given client device, in block 1415. Later, the semi-structured database server 170 executes blocks 1320, 1330 and 1335 of FIG. 13, 1420, and in a further example, the semi-structured database server 170 may further execute block 1325 of FIG. 13, 1425, such that the flat-indexed database is expected to have the most up-to-date indexing for nodes sharing the given node identifier. At this point, the given client device sends a second search query to the semi-structured database server 170, in block 1430. In an example, the second search query may search for node names that are indexed in the flat-indexed database. In this example, the semi-structured database server 170 executes the search query for the given document in the flat-indexed database only, in block 1435, and returns any search results to the given client device, in block 1440.

While the processes are described as being performed by the semi-structured database server 170, as noted above, the semi-structured database server 170 can be implemented as a client device, a network server, an application that is embedded on a client device and/or network server, and so on. Hence, the apparatus that executes the processes in various example embodiments is intended to be interpreted broadly.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
obtaining a first data entry to be indexed at a first target node with a given node identifier within a given document among the set of documents;
indexing, in a label-path indexed database, the first data entry in accordance with a label-path indexing protocol that records both a path between the root node and the first target node and the given node identifier for the first target node;
determining that a number of paths from the root node to non-root nodes that share the given node identifier exceeds a threshold;
obtaining, after the determining, a second data entry to be indexed at a second target node with the given node identifier within the given document; and
indexing, in a flat-indexed database in response to the determining, the second data entry in accordance with a flat indexing protocol that records the given node identifier for the second target node without recording the path between the root node and the second target node.

2. The method of claim 1, further comprising:
obtaining, after the determining, a search query that requires a search of nodes sharing the given node identifier within the given document; and
executing the search query by performing a first search of one or more nodes sharing the given node identifier within the label-path indexed database and performing a second search of at least one node sharing the given node identifier within the flat-indexed database.

3. The method of claim 1, further comprising:
obtaining, after the determining, a third data entry to be indexed at a given target node with the given node identifier within the given document, the given target node already existing in the label-path indexed database; and
indexing, in the label-path indexed database, the third data entry in accordance with the label-path indexing protocol based on the given target node already existing in the label-path indexed database.

4. The method of claim 3, further comprising:
creating a node context for the given target node in the flat-indexed database without indexing the third data entry in the created node context.

5. The method of claim 1, further comprising:
in response to the determining:
re-indexing each data entry in the label-path indexed database that is indexed at any target node sharing the given node identifier within the given document to the flat-indexed database in accordance with the flat indexing protocol.

6. The method of claim 5, further comprising:
obtaining, after the re-indexing, a search query that requires a search of nodes sharing the given node identifier within the given document; and
executing the search query by performing a single search within the flat-indexed database only based on the re-indexing.

7. The method of claim 5, further comprising:
in response to the re-indexing:
deleting each label-path index in the label-path indexed database for each re-indexed data entry.

8. The method of claim 1, further comprising:
obtaining, after the indexing, a search query that requires a search of nodes with a different node identifier than the given node identifier within the given document;
determining that a given number of paths from the root node to non-root nodes that share the different node identifier does not exceed the threshold; and
executing the search query by performing a search of one or more nodes sharing the different node identifier within the flat-indexed database.

9. The method of claim 1, further comprising:
obtaining, after the determining, a third data entry to be indexed at a given target node a different node identifier than the given node identifier within the given document;
determining that a given number of paths from the root node to non-root nodes that share the different node identifier does not exceed the threshold; and
indexing, in the label-path indexed database, the third data entry in accordance with the label-path indexing protocol.

10. The method of claim 1, wherein the semi-structured database is an Extensible Markup Language (XML) database or a JavaScript Object Notation (JSON) database.

11. A method of performing a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
obtaining a first data entry to be indexed at a first target node with a given node identifier within a given document among the set of documents;
indexing, in a label-path indexed database, the first data entry in accordance with a label-path indexing protocol that records both a path between the root node and the first target node and the given node identifier for the first target node;
redundantly indexing, in a flat-indexed database, the first data entry in accordance with a flat indexing protocol that records the given node identifier for the first target node without recording the path between the root node and the first target node;
determining that a number of paths from the root node to non-root nodes that share the given node identifier exceeds a threshold;
obtaining, after the determining, a second data entry to be indexed at a second target node with the given node identifier within the given document; and
indexing, only in the flat-indexed database in response to the determining, the second data entry in accordance with the flat indexing protocol.

12. The method of claim 11, further comprising:
in response to the determining:
deleting each label-path index for each data entry in the label-path indexed database with an associated target node that shares the given node identifier.

13. The method of claim 11, further comprising:
obtaining, after the determining, a search query that requires a search of nodes sharing the given node identifier within the given document; and
executing the search query by performing a single search within the flat-indexed database only.

14. The method of claim 11, further comprising:
obtaining, after the determining, a search query that requires a search of nodes sharing a different node identifier than the given node identifier within the given document; and
executing the search query by performing a single search within the label-path indexed database only.

15. The method of claim 11, further comprising:
obtaining, after the determining that the number of paths from the root node to the non-root nodes that share the given node identifier exceeds the threshold, a third data entry to be indexed at a third target node with a different node identifier than the given node identifier within the given document;
determining that a given number of paths from the root node to non-root nodes that share the different node identifier does not exceed the threshold; and
indexing, in the label-path indexed database, the third data entry in accordance with the label-path indexing protocol.

16. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
logic configured to obtain a first data entry to be indexed at a first target node with a given node identifier within a given document among the set of documents;
logic configured to index, in a label-path indexed database, the first data entry in accordance with a label-path indexing protocol that records both a path between the root node and the first target node and the given node identifier for the first target node;
logic configured to determine that a number of paths from the root node to non-root nodes that share the given node identifier exceeds a threshold;
logic configured to obtain, after the determination, a second data entry to be indexed at a second target node with the given node identifier within the given document; and
logic configured to index, in a flat-indexed database in response to the determination, the second data entry in accordance with a flat indexing protocol that records the given node identifier for the second target node without recording the path between the root node and the second target node.

17. The server of claim 16, further comprising:
logic configured to obtain, after the determination, a search query that requires a search of nodes sharing the given node identifier within the given document; and
logic configured to execute the search query by performing a first search of one or more nodes sharing the given node identifier within the label-path indexed database and performing a second search of at least one node sharing the given node identifier within the flat-indexed database.

18. The server of claim 16, further comprising:
logic configured to obtain, after the determination, a third data entry to be indexed at a given target node with the given node identifier within the given document, the given target node already existing in the label-path indexed database; and
logic configured to index, in the label-path indexed database, the third data entry in accordance with the label-path indexing protocol based on the given target node already existing in the label-path indexed database.

19. The server of claim 18, further comprising:
logic configured to create a node context for the given target node in the flat-indexed database without indexing the third data entry in the created node context.

20. The server of claim 16, further comprising:
logic configured to, in response to the determination, re-index each data entry in the label-path indexed database that is indexed at any target node sharing the given node identifier within the given document to the flat-indexed database in accordance with the flat indexing protocol.

21. The server of claim 20, further comprising:
logic configured to, after the re-indexing, obtain a search query that requires a search of nodes sharing the given node identifier within the given document; and
logic configured to execute the search query by performing a single search within the flat-indexed database only based on the re-indexing.

22. The server of claim 20, further comprising:
logic configured to, in response to the re-indexing, delete each label-path index in the label-path indexed database for each re-indexed data entry.

23. The server of claim 16, further comprising:
logic configured to obtain, after the indexing, a search query that requires a search of nodes with a different node identifier than the given node identifier within the given document;
logic configured to determine that a given number of paths from the root node to non-root nodes that share the different node identifier does not exceed the threshold; and
logic configured to execute the search query by performing a search of one or more nodes sharing the different node identifier within the flat-indexed database.

24. The server of claim 16, further comprising:
logic configured to obtain, after the determination, a third data entry to be indexed at a given target node a different node identifier than the given node identifier within the given document;
logic configured to determine that a given number of paths from the root node to non-root nodes that share the different node identifier do not exceed the threshold; and
logic configured to index, in the label-path indexed database, the third data entry in accordance with the label-path indexing protocol.

25. The server of claim 16, wherein the semi-structured database is an Extensible Markup Language (XML) database or JavaScript Object Notation (JSON) database.

26. A server that is configured to perform a search within a semi-structured database that is storing a set of documents, each document in the set of documents being organized with a tree-structure that contains a plurality of nodes, the plurality of nodes for each document in the set of documents including a root node and at least one non-root node, each of the plurality of nodes including a set of node-specific data entries, comprising:
logic configured to obtain a first data entry to be indexed at a first target node with a given node identifier within a given document among the set of documents;
logic configured to index, in a label-path indexed database, the first data entry in accordance with a label-path indexing protocol that records both a path between the root node and the first target node and the given node identifier for the first target node;
logic configured to redundantly index, in a flat-indexed database, the first data entry in accordance with a flat indexing protocol that records the given node identifier for the first target node without recording the path between the root node and the first target node;
logic configured to determine that a number of paths from the root node to non-root nodes that share the given node identifier exceeds a threshold;
logic configured to obtain, after the determining, a second data entry to be indexed at a second target node with the given node identifier within the given document; and
logic configured to index, only in the flat-indexed database in response to the determining, the second data entry in accordance with the flat indexing protocol.

27. The server of claim 26, further comprising:
logic configured to, in response to the determination, delete each label-path index for each data entry in the label-path indexed database with an associated target node that shares the given node identifier.

28. The server of claim 26, further comprising:
logic configured to obtain, after the determination, a search query that requires a search of nodes sharing the given node identifier within the given document; and
logic configured to execute the search query by performing a single search within the flat-indexed database only.

29. The server of claim 26, further comprising:
logic configured to obtain, after the determination, a search query that requires a search of nodes sharing a different node identifier than the given node identifier within the given document; and
executing the search query by performing a single search within the label-path indexed database only.

30. The server of claim 26, further comprising:
logic configured to obtain, after the determination that the that the number of paths from the root node to the non-root nodes that share the given node identifier exceeds the threshold, a third data entry to be indexed at a third target node with a different node identifier than the given node identifier within the given document;
logic configured to determine that a given number of paths from the root node to non-root nodes that share the different node identifier do not exceed the threshold; and
logic configured to index, in the label-path indexed database, the third data entry in accordance with the label-path indexing protocol.
